(19) United States
(12) Patent Application Publication
(10) Pub. No.: US 2013/0133828 A1
(43) Pub. Date: May 30, 2013

(54) BONDING APPARATUS, BONDING SYSTEM AND BONDING METHOD

(71) Applicant: TOKYO ELECTRON LIMITED, Tokyo (JP)

(72) Inventors: Naoto YOSHITAKA, Koshi City (JP); Shintaro SUGIHARA, Koshi City (JP)

(73) Assignee: TOKYO ELECTRON LIMITED, Tokyo (JP)

(21) Appl. No.: 13/683,129

(22) Filed: Nov. 21, 2012

(30) Foreign Application Priority Data
Nov. 25, 2011 (JP) 2011-257876

(51) Int. Cl. B29C 65/00

(52) U.S. Cl. CPC B29C 65/00
USPC 156/285; 156/382

(57) ABSTRACT

A bonding apparatus for bonding a substrate to be processed and a support substrate including, a first holding unit which holds the substrate to be processed, a second holding unit disposed to face the first holding unit and configured to hold the support substrate, a pressurizing mechanism including a vertically-expansible pressure vessel which is installed to cover the substrate to be processed held by the first holding unit and the support substrate held by the second holding unit, the pressurizing mechanism being installed in any one of the first holding unit and the second holding unit and configured to flow air into the pressure vessel and press the second holding unit and the first holding unit towards each other, an internally-sealable processing vessel which receives the first holding unit, the second holding unit and the pressure vessel, and a depressurization mechanism which depressurizes an internal atmosphere of the processing vessel.

### CROSS-REFERENCE TO RELATED APPLICATION

This application claims the benefit of Japanese Patent Application No. 2011-257876, filed on Nov. 25, 2011, in the Japan Patent Office, the disclosure of which is incorporated herein in its entirety by reference.

### TECHNICAL FIELD

The present disclosure relates to a bonding apparatus which bonds a substrate to be processed and a support substrate, and a bonding system including the bonding apparatus, and a bonding method using the bonding apparatus.

### BACKGROUND

In recent years, for example, semiconductor wafers (hereinafter, referred to as “wafers”) are increasing in their diameter in manufacturing semiconductor devices. In addition, there is a desire to make wafers thin in a specified process such as mounting or the like. However, a large-diameter thin wafer is likely to be bent or cracked if the wafer is carried or polished. As such, to prevent these damages, the wafer is bonded to another wafer or a glass substrate as a support substrate.

Such bonding between the wafer and the support substrate is performed by interposing an adhesive therebetween in, e.g., a bonding apparatus. The bonding apparatus includes, for example, a first holding unit which holds the wafer, a second holding unit which holds the support substrate, an air suction mechanism which suctions an atmosphere of a bonded space between the first and second holding units, a seal member, e.g., O-ring, which airtightly maintains the bonded space, and a pressurizing mechanism which press the second holding unit toward the first holding unit. The second holding unit is an elastic body in which one portion of the second holding unit is bent with a predetermined pressure. In order to prevent voids from being generated between the wafer and the support substrate, the bonding apparatus discharges an atmosphere of the bonded space, bends the one portion of the second holding unit which holds the support substrate, and makes the bent portion of the support substrate contact with the wafer. Thereafter, the bonding apparatus further discharges the atmosphere of the bonded space, makes the entire surface of the support substrate contact with the entire surface of the wafer, and presses the wafer and the support substrate, thereby bonding the wafer and the support substrate.

However, in the conventional bonding apparatus, when the support substrate is brought into contact with the wafer, the support substrate is dropped from the second holding unit, whereby a misalignment between the support substrate and the wafer is occurred. This leads to an improper bonding between the wafer and the support substrate.

In addition, the second holding unit may adsorb the support substrate with a strong force to prevent the support substrate from being dropped from the second holding unit. Unfortunately, since the atmosphere of the bonded space between the first holding unit and the second holding unit is discharged with a predetermined vacuum pressure, there is a need for the second holding unit to adsorb the support substrate with force stronger than the vacuum pressure of the bonded space. This makes the bonding apparatus bulky and structurally complicated, and increases the cost of bonding the wafer and the support substrate.

Further, since the atmosphere of the bonded space between the first holding unit and the second holding unit is discharged with the predetermined vacuum pressure, there is a need to increase a pressure produced when the pressurizing mechanism presses the wafer and the support substrate than the predetermined vacuum pressure at least. This may cause damages to devices provided on the wafer, for example.

When the pressurizing mechanism presses the wafer and the support substrate, the O-ring which is disposed outside of the wafer and the support substrate, is simultaneously pressed. This causes a reaction of the O-ring in a direction opposite to the press direction by the pressurizing mechanism. The reaction makes a pressure to be applied to peripheral portions of the wafer and the support substrate lower than a pressure to be applied to their central portions, thus making it difficult for the pressurizing mechanism to press the wafer and the support substrate with a uniform in-plane load. This prevents the wafer and the support substrate from being stably bonded.

### SUMMARY

The present disclosure provides to some embodiments of a bonding apparatus which bonds a substrate to be processed and a support substrate, a bonding system including the bonding apparatus, and a bonding method for use in the bonding apparatus.

According to one embodiment of the present disclosure, provided is a bonding apparatus for bonding a substrate to be processed and a support substrate, including, a first holding unit configured to hold the substrate to be processed, a second holding unit disposed to face the first holding unit and configured to hold the support substrate, a pressurizing mechanism installed in any one of the first holding unit and the second holding unit and including a vertically-expansible/contractible pressure vessel which is installed to cover the substrate to be processed held by the first holding unit and the support substrate held by the second holding unit, the pressurizing mechanism being installed in any one of the first holding unit and the second holding unit and configured to flow air into the pressure vessel and press the second holding unit and the first holding unit towards each other, an internally-sealable processing vessel configured to receive the first holding unit, the second holding unit and the pressure vessel, and a depressurization mechanism configured to depressurize an internal atmosphere of the processing vessel.

According to another embodiment of the present disclosure, provided is a bonding system including the above-mentioned bonding apparatus, including, a process station including the bonding apparatus, a coating unit configured to coat an adhesive onto a substrate to be processed or a support substrate, a heat treatment unit configured to heat the substrate to be processed or the support substrate onto which the adhesive is coated to a predetermined temperature, a transfer zone through which the substrate to be processed, the support substrate or an overlapped wafer obtained by overlapping the substrate to be processed and the support substrate is transferred to the coating unit, the heat treatment unit and the bonding apparatus, and a carry-in/carry-out station in which the substrate to be processed, the support substrate or the overlapped wafer is carried into/carried out of the process station.

According to another embodiment of the present disclosure, provided is a method of bonding a substrate to be processed and a support substrate using a bonding apparatus, wherein the bonding apparatus includes, a first holding unit configured to hold the substrate to be processed, a second holding unit disposed to face the first holding unit and configured to hold the support substrate, a pressurizing mechanism including a vertically-expansible pressure vessel which is installed to cover the substrate to be processed held by the first holding unit and the support substrate held by the second holding unit, the pressurizing mechanism being installed in any one of the first holding unit and the second holding unit and configured to flow air into the pressure vessel and press the second holding unit and the first holding unit towards each other, an internally-sealable processing vessel configured to receive the first holding unit, the second holding unit and the pressure vessel, and a depressurization mechanism configured to depressurize an internal atmosphere of the processing vessel, wherein the method comprises, disposing the substrate to be processed held by the first holding unit and the support substrate held by the second holding unit oppositely to each other and depressurizing the interior of the processing vessel in vacuum by the depressurization mechanism, and pressing the second holding unit toward the first holding unit by the pressurizing mechanism while maintaining the interior of the processing vessel in vacuum.

### BRIEF DESCRIPTION OF THE DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a schematic plane view showing a configuration of a bonding system according to one embodiment of the present disclosure.

FIG. 2 is a side view showing an inner configuration of the bonding system shown in FIG. 1.

FIG. 3 is a side view of a wafer to be processed and a support wafer.

FIG. 4 is a traverse sectional view showing a schematic configuration of a bonding apparatus.

FIG. 5 is a plane view showing a schematic configuration of a conveyance unit.

FIG. 6 is a plane view showing a schematic configuration of a conveyance arm.

FIG. 7 is a side view showing a schematic configuration of the conveyance arm.

FIG. 8 is a plane view showing a schematic configuration of an inverting unit.

FIG. 9 is a side view showing a schematic configuration of the inverting unit.

FIG. 10 is a side view showing a schematic configuration of the inverting unit.

FIG. 11 is a side view showing a schematic configuration of a holding arm and a holding member.

FIG. 12 is a view showing a position relationship between the conveyance unit and the inverting unit.

FIG. 13 is a side view showing a schematic configuration of a transfer unit.

FIG. 14 is a view showing that the transfer unit is disposed within the bonding apparatus

FIG. 15 is a plane view showing a schematic configuration of a first transfer arm.

FIG. 16 is a side view showing a schematic configuration of the first transfer arm.

FIG. 17 is a plane view showing a schematic configuration of a second transfer arm.

FIG. 18 is a side view showing a schematic configuration of the second transfer arm.

FIG. 19 is a view showing that cutouts are formed on the second holding unit.

FIG. 20 is a vertical sectional view showing a schematic configuration of a bonding unit.

FIG. 21 is a plane view showing a schematic configuration of a first holding unit and a moving mechanism.

FIG. 22 is a vertical sectional view showing a schematic configuration of the bonding unit.

FIG. 23 is a vertical sectional view showing a schematic configuration of a coating unit.

FIG. 24 is a traverse sectional view showing a schematic configuration of the coating unit.

FIG. 25 is a vertical sectional view showing a schematic configuration of a heat treatment unit.

FIG. 26 is a traverse sectional view showing a schematic configuration of the heat treatment unit.

FIG. 27 is a flowchart showing main processes of the bonding treatment.

FIG. 28 is a view showing that horizontal positions of the wafer to be processed and the support wafer are adjusted.

FIG. 29 is a view showing that the interior of the processing vessel becomes a vacuum state.

FIG. 30 is a view showing that the wafer to be processed and the support wafer are bonded.

FIG. 31 is a vertical sectional view showing a schematic configuration of a bonding unit according to another embodiment of the present disclosure.

FIG. 32 is a plane view showing a schematic configuration of a first holding unit according to another embodiment of the present disclosure.

FIG. 33 is a view showing a schematic configuration of an attracting pad.

FIG. 34A is a view showing the attracting pad before holding the wafer to be processed.

FIG. 34B is a view showing that the wafer to be processed is held by the attracting pad.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

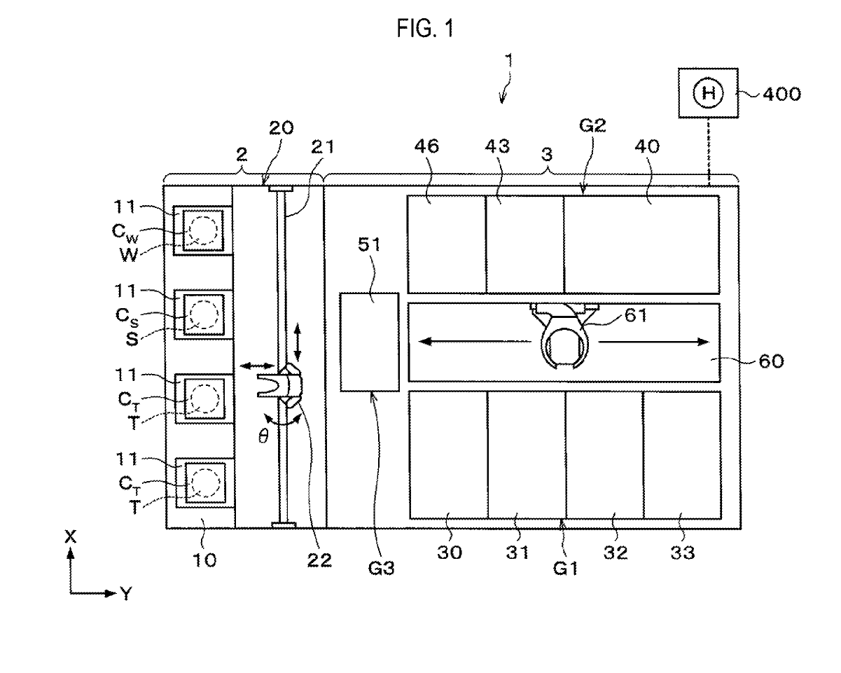

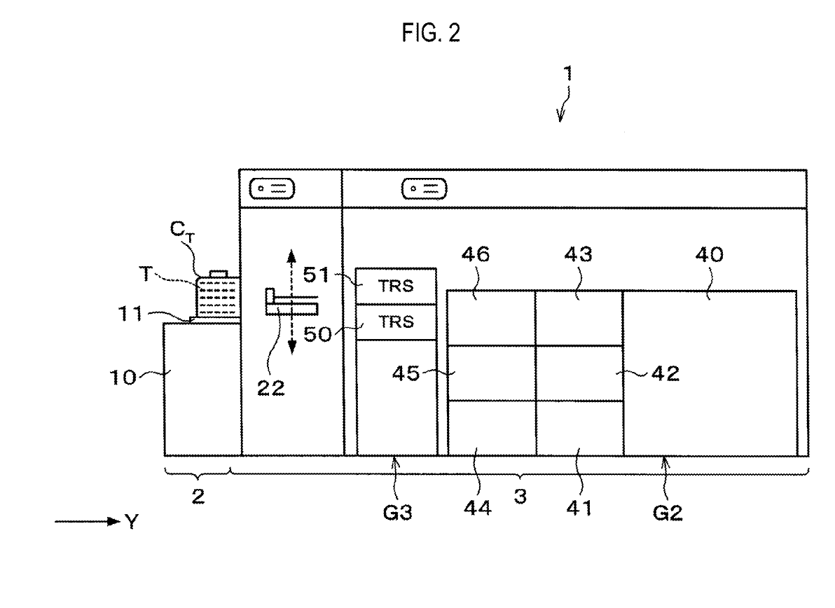

Embodiments of the present disclosure will now be described in detail with reference to the drawings. FIG. 1 is a schematic plane view showing a configuration of a bonding system 1 according to one embodiment of the present disclosure. FIG. 2 is a side view showing an inner configuration of the bonding system 1.

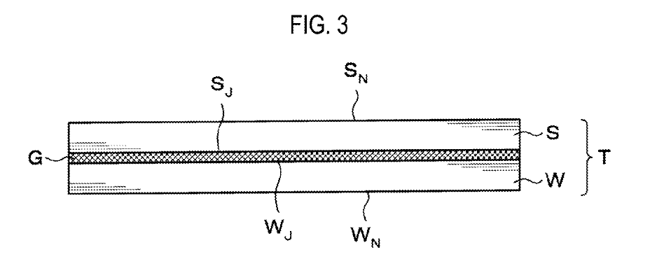

In the bonding system 1, as shown in FIG. 3, a wafer to be processed W, as a substrate to be processed, and a support wafer S, as a support substrate are bonded using, e.g., an adhesive G. Hereinafter, in the wafer to be processed W, a surface that is bonded to the support wafer S through the adhesive G will be referred to as a “bonding surface W_{J}” as a front surface, and an opposite surface of the bonding surface W_{J} will be referred to as a “non-bonding surface W_{N}” as a rear surface. Similarly, in the support wafer S, a surface that is bonded to the wafer to be processed W through the adhesive G will be referred to as a “bonding surface S_{J}” as a front surface, and an opposite surface of the bonding surface S_{J} will be referred to as a “non-bonding surface S_{N}” as a rear surface. Further, in the bonding system 1, an overlapped wafer T as an overlapped substrate is formed by bonding the wafer to be processed W and the support wafer S. The wafer to be processed W is a wafer to be used as a product. In the wafer to be processed W, a plurality of electronic circuits are formed on the bonding surface W_{J}, and the non-bonding surface W_{N} is subjected to polishing. The support wafer S has the same diameter as that of the wafer to be processed W and is a wafer acting to support the wafer to be processed W. While in this embodiment, the wafer has been described to be used as the support substrate S, the present disclosure is not limited thereto. For example, another substrate such as a glass substrate may be used as the support substrate.

As shown in FIG. 1, the bonding system 1 includes a carry-in/carry-out station 2 in which cassettes C_{W}, C_{S}, and C_{T} are carried in and out between the carry-in/carry-out station 2 and the outside, and a process station 3 including various processing units which are configured to perform a predetermined process on the wafers to be processed W, the support wafers S and the overlapped wafers T, wherein the carry-in/carry-out station 2 and the process station 3 are connected serially. The cassettes C_{W}, C_{S}, and C_{T} are configured to accommodate a plurality of wafers to be processed W, a plurality of support wafers S and a plurality of overlapped wafers T therein, respectively.

A cassette loading table 10 is disposed in the carry-in/carry-out station 2. A plurality of (e.g., four) cassette loading boards 11 is installed on the cassette loading table 10. The cassette loading boards 11 are arranged in a line along an X-axis direction (vertical direction in FIG. 1). The cassette loading boards 11 can load thereon the cassettes C_{W}, C_{S} and C_{T}, when they are carried in and out between the carry-in/carry-out station 2 and the outside of the bonding system 1, respectively. In this way, the carry-in/carry-out station 2 can hold the plurality of wafers to be processed W, the plurality of support wafers S and the plurality of overlapped wafers T. The number of the cassette loading boards 11 is not limited to this embodiment but may be selected as appropriate. One of the cassettes may be used as a collection cassette for collecting defective wafers. That is, the collection cassette is provided to receive the defective wafers having a defect due to various factors in the bonding of the wafer to be processed W and the support wafer S, except normal overlapped wafers T. In this embodiment, one of the plurality of cassettes C_{T} is used as the collection cassette for collecting the defective wafers and the other cassette C_{T} is used to receive the normal overlapped wafers T.

In the carry-in/carry-out station 2, a wafer transfer section 20 is disposed adjacent to the cassette loading table 10. The wafer transfer section 20 is provided with a wafer transfer unit 22 configured to move along a transfer path 21 extending in the X-axis direction. The wafer transfer unit 22, which is movable in a vertical direction and is also rotatable around the vertical axis (or in θ direction), transfers the wafer to be processed W, the support wafer S and the overlapped wafer T between the cassettes C_{W}, C_{S} and C_{T} loaded on the respective cassette loading boards 11 and transition units (TRS) 50 and 51 of a third processing block G3 of the process station 3, which will be described later.

The process station 3 is provided with a plurality of (e.g., three) processing blocks G1, G2 and G3 which include various processing units. The processing block G1 is disposed at the front side of the process station 3 (at the positive X-axis direction side in FIG. 1). The processing block G2 is disposed at the rear side of the process station 3 (at the negative X-axis direction side in FIG. 1). The third processing block G3 is disposed at a side of the carry-in/carry-out station 2 (at the negative Y-axis direction side in FIG. 1).

The processing block G1 is provided with bonding units 30 to 33, which are configured to press the wafer to be processed W and the support wafer S with the adhesive G interposed therebetween to bond them together. The bonding units 30 to 33 are arranged at the carry-in/carry-out station 2 along the Y-axis direction in that order.

As shown in FIG. 2, the processing block G2 is provided with a coating unit 40 configured to coat the adhesive G on the wafer to be processed W, heat treatment units 41 to 43 configured to heat the wafer to be processed W with the adhesive G coated thereon to a predetermined temperature, and heat treatment units 44 to 46 having the same function as that of the heat treatment units 41 to 43, which are arranged in a direction toward the carry-in/carry-out station 2 (in the negative Y-axis direction in FIG. 1) in that order. The heat treatment units 41 to 43 and the heat treatment units 44 to 46 are stacked in three stages in order from the bottom, respectively. The number of the heat treatment units 41 to 46, and vertical and horizontal arrangements may be selected as appropriate.

The third processing block G3 is provided with the transition units 50 and 51 configured to transition the wafer to be processed W, the support wafer S and the overlapped wafer T, which are arranged in two stages in order from the bottom.

As shown in FIG. 1, an area which is bounded by the processing blocks G1 to G3 is defined as a wafer transfer zone 60. For example, a wafer transfer unit 61 is disposed in the wafer transfer zone 60. Further, the pressure within the wafer transfer zone 60 is set to an atmosphere pressure or higher. In the wafer transfer zone 60, the wafer to be processed W, the support wafer S and the overlapped wafer T are transferred under such an atmospheric system.

The wafer transfer unit 61 is equipped with a transfer arm (not shown) which is movable in a vertical direction, horizontal directions (the X and Y-axis directions) and is rotatable around the vertical axis. The wafer transfer unit 61 moves inside the wafer transfer zone 60 so that the wafer to be processed W, the support wafer S and the overlapped wafer T are transferred to a respective processing unit installed in each of the processing block G1, the processing block G2 and the third processing block G3.

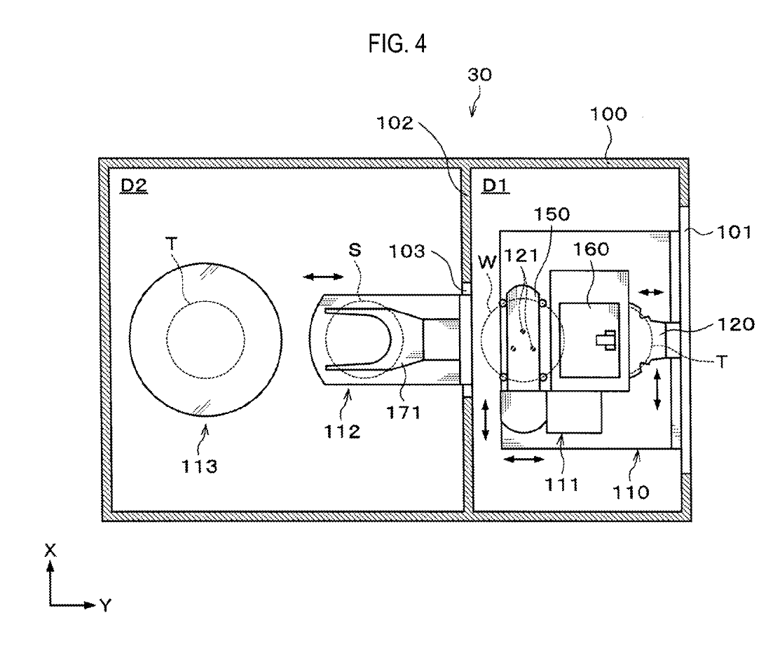

Next, a description will be made on a configuration of the aforementioned bonding units 30 to 33. The bonding unit 30 includes an internally-sealable processing vessel 100 as shown in FIG. 4. An inlet/outlet 101 through which the wafer to be processed W, the support substrate and the overlapped wafer T are passed, is formed in a lateral side of the processing vessel 100 toward the wafer transfer zone 60. An opening/closing shutter (not shown) is installed at the inlet/outlet 101.

The interior of the processing vessel 100 is partitioned into a pre-processing section D1 and a bonding section D2 by an internal wall 102. The inlet/outlet 101 as described above is formed in the lateral side of the processing vessel 100 in the pre-processing section D1. Further, an inlet/outlet 103 through which the wafer to be processed W, the support wafer S and the overlapped wafer T is passed, is formed in the internal wall 102.

A conveyance unit 110, which relays the wafer to be processed W, the support wafer S and the overlapped wafer T between the pre-processing section D1 and the wafer transfer zone 60, is installed inside the pre-processing section D1. The conveyance unit 110 is disposed near the inlet/outlet 101. Further, the conveyance unit 110 may be disposed in a plurality of (e.g., two) stages in the vertical direction such that two of the wafer to be processed W, the support wafer S and the overlapped wafer T are simultaneously transferred, which will be described later. For example, the wafer to be processed W or the support wafer S before the bonding may be transferred by one conveyance unit 110, and the overlapped wafer T after the bonding may be transferred by the other conveyance unit 110. Alternatively, the wafer to be processed W may be transferred by one conveyance unit 110 before the bonding and the support wafer S may be transferred by the other conveyance unit 110 after the bonding.

In the backward side of the Y-axis direction of the pre-processing section D1, i.e., in the side of the inlet/outlet 103, for example, an inverting unit 111 configured to invert the front and rear surfaces of the support wafer S is disposed above the conveyance unit 110 in the vertical direction. Further, the inverting unit 111 can adjust a horizontal orientation of the support wafer S and also adjust a horizontal orientation of the wafer to be processed W, which will be described later.

In the forward side of the Y-axis direction of the bonding section D2, a transfer unit 112 is disposed to transfer the wafer to be processed W, the support wafer S and the overlapped wafer T between the conveyance unit 110 , the inverting unit 111 and a bonding unit 113 (which will be described later). The transfer unit 112 is mounted in the inlet/outlet 103.

In the backward side of the Y-axis direction of the bonding section D2, the bonding unit 113 is disposed to press the wafer to be processed W and the support wafer S to bond them each other by the adhesive G The bonding unit 113 acts also as the bonding apparatus of the present disclosure.

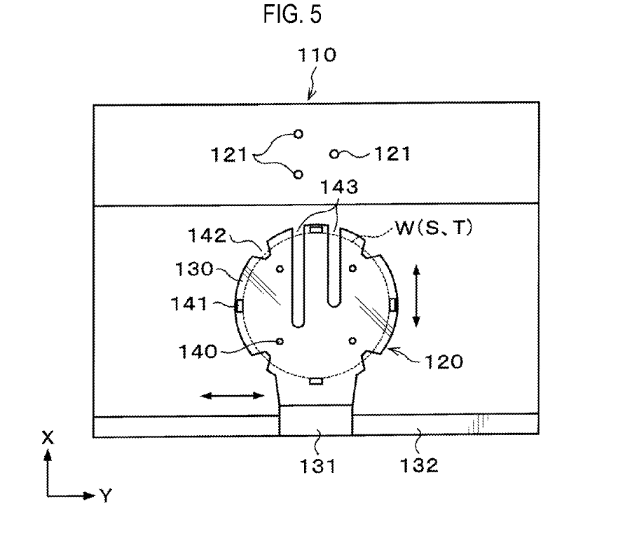

Next, a description will be made on a configuration of the aforementioned conveyance unit 110. As shown in FIG. 5, the conveyance unit 110 includes a conveyance arm 120 and wafer support pins 121. The conveyance arm 120 is configured to relay the wafer to be processed W, the support wafer S and the overlapped wafer T between the exterior of the bonding unit 30, i.e., the wafer transfer unit 61 and the wafer support pins 121. The wafer support pins 121 are disposed at a plurality of (e.g., three) locations to support the wafer to be processed W, the support wafer S and the overlapped wafer T.

The conveyance arm 120 includes an arm part 130 for holding the wafer to be processed W, the support wafer S and the overlapped wafer T, and an arm driving part 131 equipped with a motor. The arm part 130 is of a circular disc shape. The arm driving part 131 is configured to move the arm part 130 in the X-axis direction (the vertical direction in FIG. 5). Further, the arm driving part 131, which is mounted in a rail 132 extending in the Y-axis direction (left-right direction in FIG. 5), is movable along the rail 132. With this configuration, the conveyance arm 120 is movable in the horizontal direction (the X and Y-axis directions), which allows for smooth transfers of the wafer to be processed W, the support wafer S and the overlapped wafer T between the wafer transfer unit 61 and the wafer support pins 121.

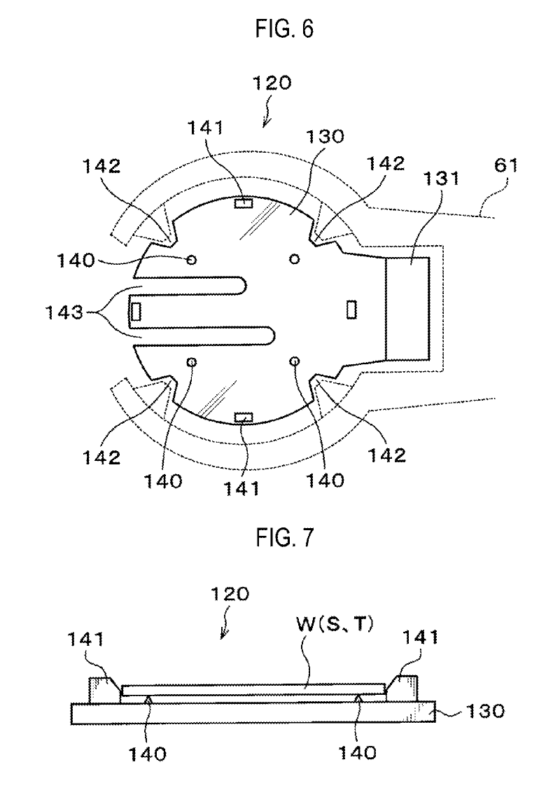

As shown in FIGS. 6 and 7, a plurality of (e.g., four) wafer support pins 140 for supporting the wafer to be processed W, the support wafer S and the overlapped wafer T are disposed on the arm part 130. Further, a plurality of (e.g., four) guides 141 for positioning the wafer to be processed W, the support wafer S and the overlapped wafer T supported by the wafer support pins 140 are formed on the arm part 130. The guides 141 are formed to guide lateral sides of the wafer to be processed W, the support wafer S and the overlapped wafer T.

As shown in FIGS. 5 and 6, a plurality of (e.g., four) cutouts 142 are formed on the outer periphery of the arm part 130. The cutouts 142 prevent a transfer arm (not shown) of the wafer transfer unit 61 from interfering with the arm part 130 when the wafer to be processed W, the support wafer S and the overlapped wafer T are transferred from the transfer arm of the wafer transfer unit 61 to the conveyance arm 120.

Two slits 143, which extend in the X-axis direction, are formed in the arm part 130. The slits 143 are formed to extend from end faces of the arm part 130 facing the wafer support pins 121 near the central portion of the arm part 130. The slits 143 prevent the arm part 130 from interfering with the wafer support pins 121.

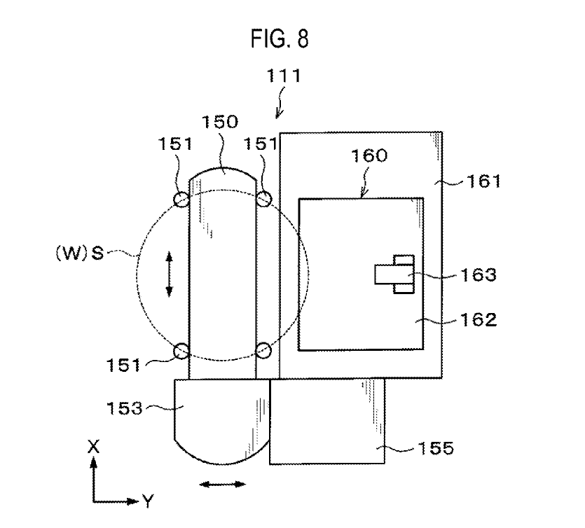

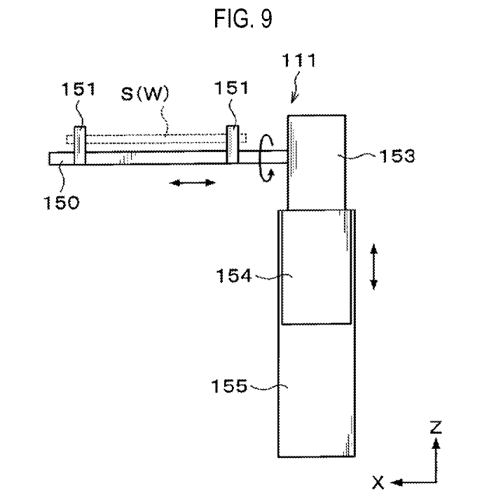

Next, a description will be made on a configuration of the aforementioned inverting unit 111. As shown in FIGS. 8 to 10, the inverting unit 111 includes a holding arm 150 configured to hold the support wafer S or the wafer to be processed W. The holding arm 150 is formed to extend in a horizontal direction (X-axis direction in FIGS. 8 and 9). Further, a plurality of (e.g., four) holding members 151 configured to hold the support wafer S or the wafer to be processed W are formed in the holding arm 150. As shown in FIG. 11, the holding members 151 are configured to horizontally move with respect to the holding arm 150. Cutouts 152 configured to hold the outer periphery of the support wafer S or the wafer to be processed W are formed in lateral sides of the holding members 151, respectively. With this configuration, the holding members 151 can hold the support wafer S or the wafer to be processed W while inserting them into the cutouts 152.

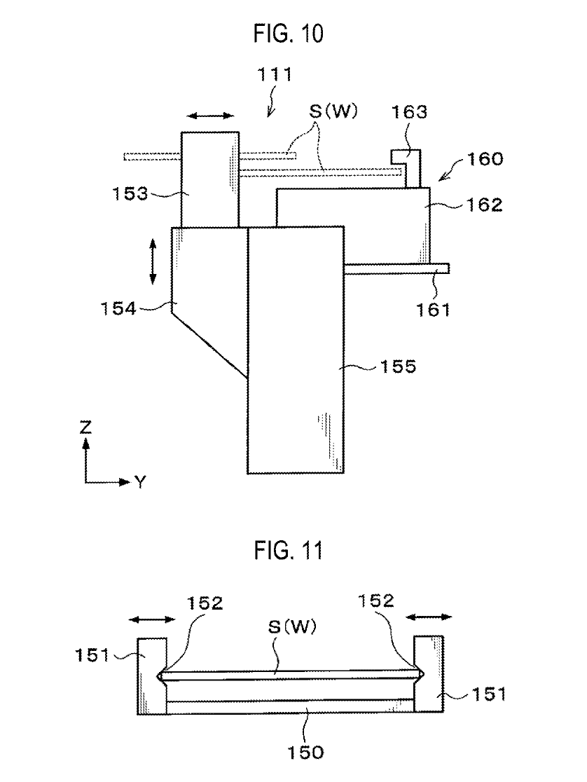

As shown in FIGS. 8 to 10, the holding arm 150 is supported by a first driving unit 153 equipped with, e.g., a motor. The first driving unit 153 allows the holding arm 150 to be rotatable around a horizontal axis and to be movable in the horizontal direction (the X-axis direction in FIGS. 8 and 9, and the Y-axis direction in FIGS. 8 and 10). The first driving unit 153 may allow the holding arm 150 to rotate around a vertical axis, and move it in the horizontal direction. A second driving unit 154 equipped with a motor is installed below the first driving unit 153. The second driving unit 154 allows the first driving unit 153 to vertically move along a vertically-extended supporting column 155. With this configuration, the first and second driving units 153 and 154 allow the support wafer S or the wafer to be processed W supported by the holding members 151 to rotate around the horizontal axis and move in the vertical and horizontal directions.

A position adjustment mechanism 160 configured to adjust a horizontal orientation of the support wafer S or the wafer to be processed W, which is supported by the holding members 151, is supported by the supporting column 155 with a support plate 161 interposed therebetween. The position adjustment mechanism 160 is disposed adjacent to the holding arm 150.

As shown in FIG. 8, the position adjustment mechanism 160 includes a base table 162, and a detection unit 163 configured to detect a position of a notch portion formed on the support wafer S or the wafer to be processed W. Further, the position adjustment mechanism 160 allows the detection unit 163 to detect the position of the notch portion of the support wafer S and the wafer to be processed W, while horizontally moving the support wafer S or the wafer to be processed W that is supported by the holding members 151 in the horizontal direction, thereby adjusting the position of the notch portion. Thus, the detection unit 163 adjusts the horizontal orientation of the support substrate S or the wafer to be processed W.

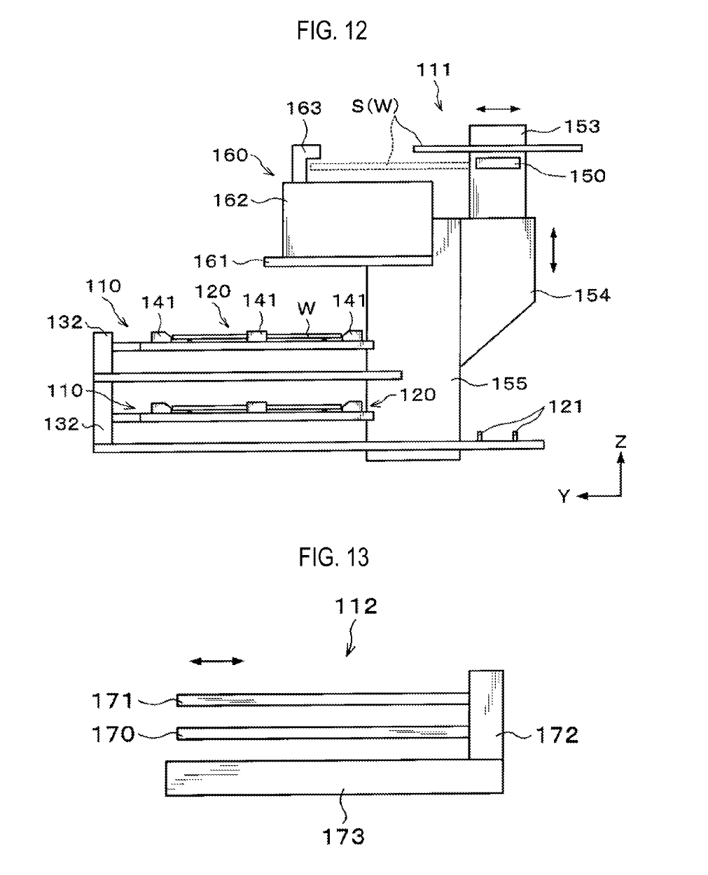

Further, as shown in FIG. 12, the conveyance unit 110 configured as above is disposed in two stages in the vertical direction, and the inverting unit 111 is disposed above the conveyance units 110 in the vertical direction. That is, each of the conveyance arms 120 of the conveyance units 110 horizontally moves below the holding arm 150 of the inverting unit 111 and the position adjustment mechanism 160. Further, the wafer support pins 121 of the conveyance unit 110 are disposed below the holding arm 150 of the inverting unit 111.

Next, a configuration of the aforementioned transfer unit 112 will be described. As shown in FIG. 13, the transfer unit 112 includes a plurality of (e.g., two) transfer arms 170 and 171. The first and second transfer arms 170 and 171 are disposed in two stages in that order from the bottom. Further, the first and second transfer arms 170 and 171 have different shapes, which will be described later.

Base end portions of the first and second transfer arms 170 and 171 are connected with an arm driving part 172 equipped with, e.g., a motor. The arm driving part 172 allows each of the first and second transfer arms 170 and 171 to independently move in the horizontal direction. The first and second transfer arms 170 and 171 and the arm driving part 172 are supported by a base table 173.

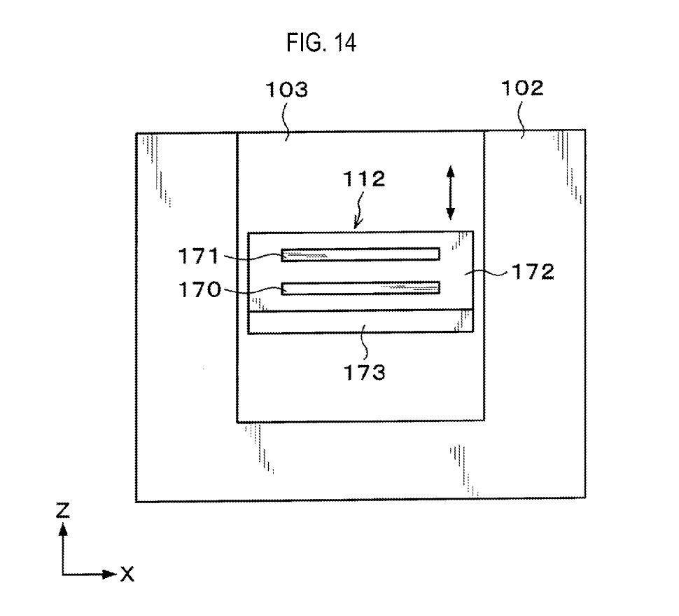

As shown in FIGS. 4 and 14, the transfer unit 112 is installed at the inlet/outlet 103 formed in the internal wall 102 of the processing vessel 100. The transfer unit 112 is configured to vertically move along the inlet/outlet 103 by a driving unit (not shown) equipped with, e.g., a motor.

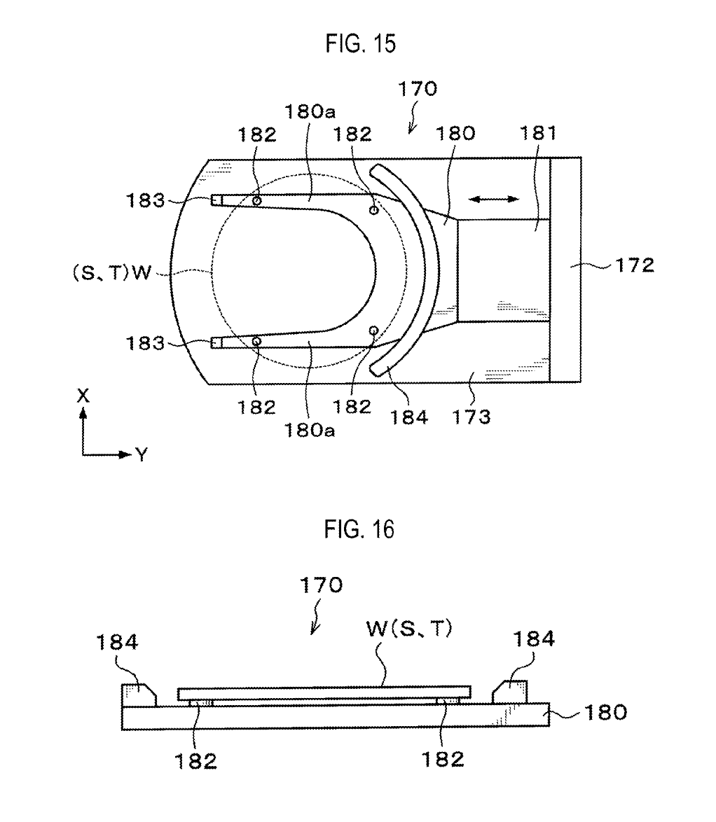

The first transfer arm 170 holds and transfers the rear surface (the non-bonding surface W_{N} or S_{N} for the wafer to be processed W or the support wafer S) of the wafer to be processed W, the support wafer S or the overlapped wafer T. As shown in FIG. 15, the first transfer arm 170 includes an arm portion 180 having two branched leading end portions 180a and 180a, and a support portion 181 which is integrated with the arm portion 180 and is configured to support the arm portion 180.

As shown in FIGS. 15 and 16, a plurality of (e.g., four) resin O-rings 182 are installed on the arm portion 180. The O-rings 182 are in contact with the rear surface of the wafer to be processed W, the support wafer S or the overlapped wafer T, which causes friction between the O-rings 182 and the rear surface of the wafer to be processed W, the support wafer S or the overlapped wafer T. This friction allows the O-rings 182 to hold the rear surface of the wafer to be processed W, the support wafer S or the overlapped wafer T. Further, the first transfer arm 170 horizontally holds the wafer to be processed W, the support wafer S or the overlapped wafer T on the O-ring 182.

Guide members 183 and 184 are installed in the outside of the wafer to be processed W, the support wafer S or the overlapped wafer T that is held by the O-rings 182. The guide members 183 are installed in each tip of the leading end portions 180a of the arm portion 180. The guide member 184, which is formed in a circular disc shape along the periphery of the wafer to be processed W, the support wafer S or the overlapped wafer T, is installed in the side of the support portion 181. The guide members 183 and 184 prevent the wafer to be processed W, the support wafer S or the overlapped wafer T from protruding or being dropped from the first transfer arm 170. When the wafer to be processed W, the support wafer S or the overlapped wafer T is held by the O-rings 182 at a suitable position, the wafer to be processed W, the support wafer S or the overlapped wafer T is not in contact with the guide members 183 and 184.

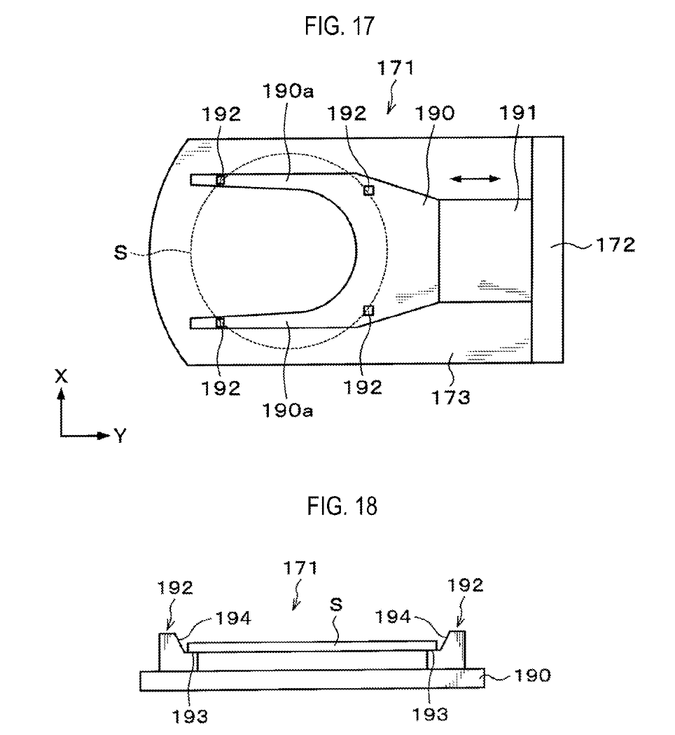

The second transfer arm 171 transfers the support wafer S while holding, for example, the front surface of the support wafer S (i.e., a peripheral portion of the bonding surface S_{J}). Specifically, the second transfer arm 171 transfers the support wafer S while holding the peripheral portion of the bonding surface S_{J} of the support wafer S whose the front and rear surfaces are inverted by the inverting unit 111. As shown in FIG. 17, the second transfer arm 171 includes an arm portion 190 having two branched leading end portions 190a and 190a, and a support portion 191 which is integrated with the arm portion 190 and is configured to support the arm portion 190.

As shown in FIGS. 17 and 18, a plurality of (e.g., four) second holding members 192 are installed on the arm portion 190. Each of the second holding members 192 includes a mounting portion 193 on which the peripheral portion of the bonding surface S_{J} of the support wafer S is mounted, and a tapered portion 194 which extends upward from the mounting portion 193 and has a configuration where an inner surface becomes wider as a function of height. The mounting portions 193 hold a peripheral portion corresponding to e.g., 1 mm or lower, from the periphery of the support wafer S toward the interior thereof Further, since the inner surface of the tapered portion 194 becomes wider as a function of height, although the support wafer S to be transferred to the second holding members 192 is laterally deviated from a predetermined position, for example, the support wafer S may be smoothly guided and be positioned into the tapered portion 194, thus being held by the mounting portion 193. And, the second transfer arm 171 can horizontally hold the support wafer S on the second holding member 192.

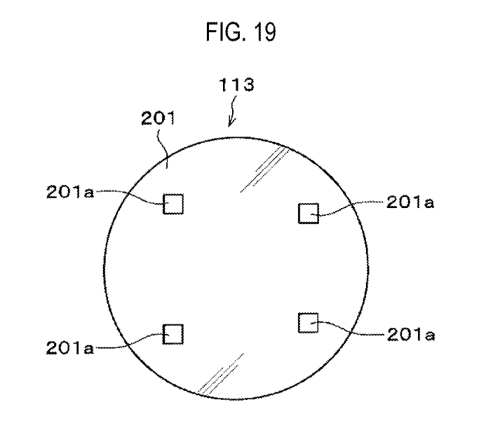

Further, as shown in FIG. 19, a plurality of (e.g., four) cutouts 201a are formed in a second holding part 201 of the bonding unit 113, which will be described later. The cutouts 201a prevent the second holding members 192 of the second transfer arm 171 from interfering with the second holding part 201 when the support wafer S is transferred from the second transfer arm 171 to the second holding part 201.

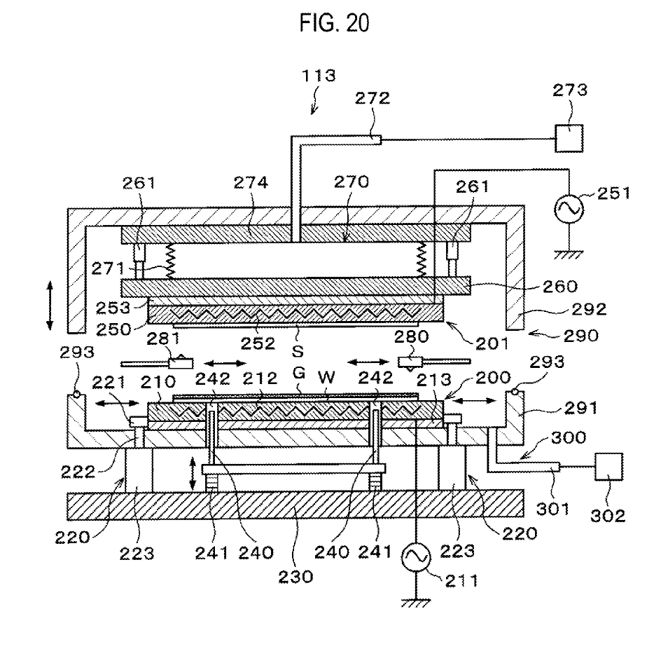

Next, a description will be made on a configuration of the aforementioned bonding unit 113. As shown in FIG. 20, the bonding unit 113 includes a first holding unit 200 configured to hold the wafer to be processed W on the top surface thereof, and a second holding unit 201 configured to adsorb the support wafer S on the bottom surface thereof The first holding unit 200 is disposed below the second holding unit 201 while being positioned to face the second holding unit 201. In other words, the wafer to be processed W held by the first holding unit 200 and the support wafer S held by the second holding unit 201 are disposed opposite from each other.

The first holding unit 200 includes an electrostatic chuck 210 configured to electrostatically adsorb the wafer to be processed W. The electrostatic chuck 210 may be made of a conductive ceramic or the like. Further, a high frequency power supply for bias 211 of, e.g., 13.56 MHz, is connected to the electrostatic chuck 210. By generating an electrostatic force on the surface of the electrostatic chuck 210, the wafer to be processed W can be electrostatically adsorbed on the electrostatic chuck 210.

A heating mechanism 212 for heating the wafer to be processed W is installed within the electrostatic chuck 210. The heating mechanism 212 may include, for example, a heater.

Further, the first holding unit 200 includes an insulating plate 213 formed on the bottom surface of the electrostatic chuck 210. The insulating plate 213 prevents heat generated when the wafer to be processed W is heated by the heating mechanism 212 from being transferred into a lower chamber 291, which will be described later.

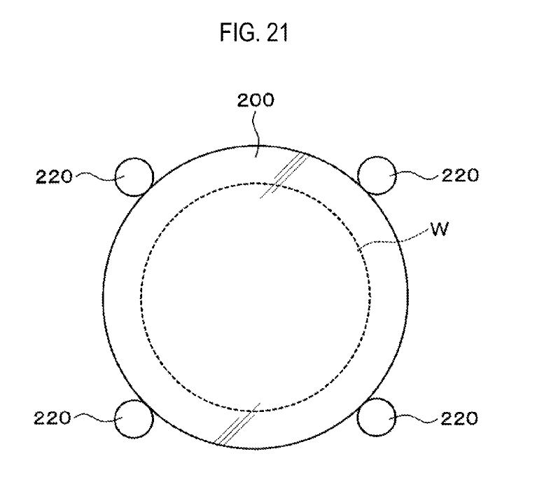

As shown in FIG. 21, a plurality of (e.g., four) moving mechanisms 220, which are configured to horizontally move the first holding unit 200, are installed in the periphery of the first holding unit 200. As shown in FIG. 20, each of the moving mechanisms 220 includes a cam 221 for moving the first holding unit 200 by contacting with the first holding unit 200, and a rotation driving unit 223 incorporating, e.g., a motor (not shown) therein, which rotates the cam 221 through a shaft 222. The cam 221 is installed to be eccentric from the center axis of the shaft 222. By rotating the cam 221 with the rotation driving unit 223, the center position of the cam 221 to the first holding unit 200 moves so that the first holding unit 200 can be horizontally moved. Further, the cam 221 is installed within the lower chamber 291 (which will be described later), and the rotation driving unit 223 is installed below the lower chamber 291. The rotation driving unit 223 is installed on a support part 230.

A plurality of (e.g., three) elevating pins 240, which support and elevate the wafer to be processed W or the overlapped wafer T from the bottom, are disposed below the first holding unit 200. Each of the elevating pins 240 is vertically movable by a corresponding elevation driver 241. Each of the elevation drivers 241 include, for example, a ball screw (not shown) and a motor (not shown) to rotate the ball screw. Further, a plurality of (e.g., three) through holes 242, which penetrate the first holding unit 200 and the lower chamber 291 in its thickness direction, is formed near the central portion of the first holding unit 200. The elevating pins 240 are inserted through the through holes 242 in such a manner that they project from the top of the first holding unit 200. The elevation drivers 241 are disposed below the lower chamber 291, which will be described later. Further, the elevation drivers 241 are installed on the support part 230.

The second holding unit 201 includes an electrostatic chuck 250 configured to electrostatically adsorb the support wafer S. The electrostatic chuck 250 may be made of a conductive ceramic or the like. Further, a high frequency power supply for bias 251 of, e.g., 13.56 MHz, is connected to the electrostatic chuck 250. By generating an electrostatic force on the surface of the electrostatic chuck 250, the support wafer S can be electrostatically adsorbed on the electrostatic chuck 250.

A heating mechanism 252 for heating the support wafer S is installed within the electrostatic chuck 250. The heating mechanism 252 may include, for example, a heater.

Further, the second holding unit 201 includes an insulating plate 253 formed on the top surface of the electrostatic chuck 250. The insulating plate 253 prevents heat generation when the support wafer S is heated by the heating mechanism 252 from being transferred into a support plate 260, which will be described later.

A plurality of support parts 261 configured to support the second holding unit 201 and a pressurizing mechanism 270 to vertically press the second holding unit 201, with the support plate 260 interposed therebetween, are provided on the top of the second holding unit 201. The support parts 261 are vertically expandable/contractable and functions as, e.g., a micrometer, and also a linear shaft. Further, the support parts 261 are disposed at, for example, three places in the outside of a pressurized container 271. The pressurizing mechanism 270 includes the pressurized container 271 provided to cover the wafer to be processed W and the support wafer S, a fluid feeding pipe 272 through which a fluid, e.g., compressed air, is fed into the pressurized container 271, and a fluid feeding source 273 configured to feed a fluid stored therein into the fluid feeding pipe 272.

The pressurized container 271 is formed of, for example, bellows made of stainless steel which can be vertically expanded/contracted. The pressurized container 271 has a bottom surface fixed to the top surface of the support plate 260 and a top surface which is fixed to the bottom surface of a support plate 274 provided above the second holding unit 201. The fluid feeding pipe 272 has one end connected to the pressurized container 271 and the other end connected to the fluid feeding source 273. Feeding of the fluid from the fluid feeding pipe 272 into the pressurized container 271 expands the pressurized container 271. At this time, since the top surface of the pressurized container 271 is in contact with the bottom surface of the support plate 274, the pressurized container 271 is expanded downward to press down the second holding unit 201 provided in the bottom surface of the pressurized container 271. In addition, since the interior of the pressurized container 271 is pressurized by the fluid and the pressurized container 271 has the same planar shape as that of the wafer to be processed W and the support wafer S, the pressurized container 271 can uniformly press the inner-plane of the second holding unit 201 (the wafer to be processed W and the support wafer S) irrespective of a parallelism between the first holding unit 200 and the second holding unit 201. A load for pressing the second holding unit 201 is adjusted by controlling the pressure of the compressed air fed into the pressurized container 271. The support plate 274 may be formed of a material having a predetermined intensity such that it is not deformed in response to a reaction produced when the second holding unit 201 is pressed by the pressurizing mechanism 270.

A first imaging unit 280 configured to image the surface of the wafer to be processed W held by the first holding unit 200 and a second imaging unit 281 configured to image the surface of the support wafer S held by the second holding unit 201 are disposed between the first holding unit 200 and the second holding unit 201. For example, a wide angle type of a CCD camera may be used as the first imaging unit 280 and the second imaging unit 281. Further, the first imaging unit 280 and the second imaging unit 281 are configured to be vertically and horizontally moved by a moving unit (not shown).

The bonding unit 113 includes an internally-sealed processing vessel 290. The processing vessel 290 accommodates therein the first holding unit 200, the second holding unit 201, the cam 221, the support plate 260, the support part 261, the pressurized container 271, the support plate 274, the first imaging unit 280 and the second imaging unit 281, as mentioned hereinabove.

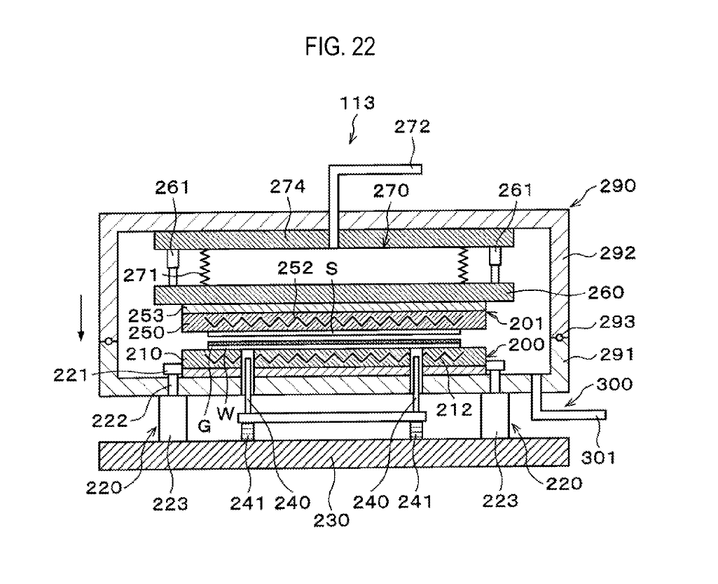

The processing vessel 290 includes the lower chamber 291 configured to support the first holding unit 200 and an upper chamber 292 configured to support the second holding unit 201. The upper chamber 292 is configured to vertically move ascend and descend by an elevating mechanism (not shown), e.g., an air cylinder. A seal member 293 configured to airtightly maintain the processing vessel 290 is provided in a contact face with the upper chamber 292 in the lower chamber 291. The seal member 293 may include, for example, an O-ring. As shown in FIG. 22, the interior of the processing vessel 290 becomes a sealed space by making the lower chamber 291 to be in contact with the upper chamber 292.

A depressurization mechanism 300 configured to reduce the internal atmosphere of the processing vessel 290 is installed within the lower chamber 291. The depressurization mechanism 300 includes an air suction pipe 301 for suctioning the internal atmosphere of the processing vessel 290 and a negative pressure generator 302, e.g., a vacuum pump, which is connected to the air suction pipe 301.

The configurations of the bonding units 31 to 33 have the same configuration as the aforementioned bonding unit 30, and, therefore a description thereof will be omitted to avoid duplication.

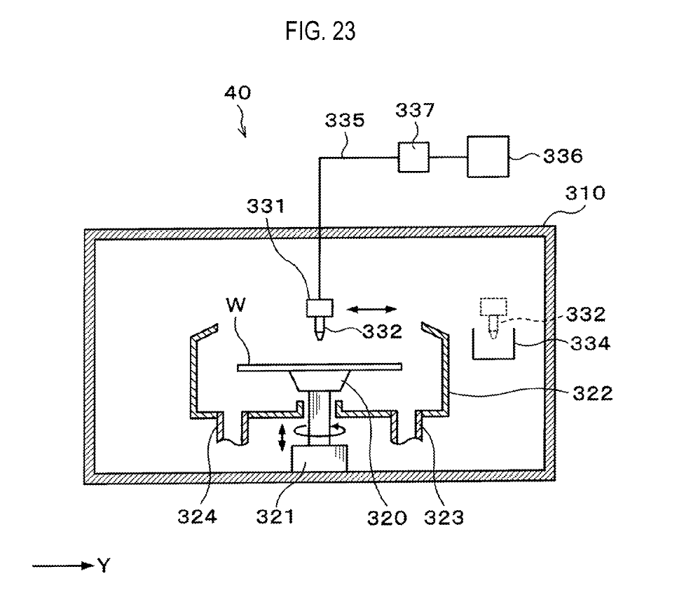

A configuration of the aforementioned coating unit 40 will be now described. As shown in FIG. 23, the coating unit 40 includes an internally-sealed processing vessel 310. An inlet/outlet (not shown) through which the wafer to be processed W is carried-in/carried-out is formed in a lateral side facing the wafer transfer zone 60 in the processing vessel 310, and an opening/closing shutter (not shown) is installed at the inlet/outlet.

A spin chuck 320 which holds and rotates the wafer to be processed W is provided in a central portion within the processing vessel 310. The spin chuck 320 includes a horizontal upper surface, on which suction holes (not shown) for suctioning, for example, the wafer to be processed W, are formed. Using the suctioning force of the suction holes, the spin chuck 320 can suction and hold the wafer to be processed W.

A chuck drive unit 321 equipped with, e.g., an electric motor, is installed below the spin chuck 320. The spin chuck 320 can be rotated at a predetermined speed by the chuck drive unit 321. The chuck drive unit 321 includes an up-down drive source (not shown) such as a cylinder or the like and can move the spin chuck 320 up and down.

A cup 322 is provided around the spin chuck 320 to receive and collect the liquid dropped or scattered from the wafer to be processed W. A discharge pipe 323 for draining the collected liquid and an exhaust pipe 324 for applying vacuum into the cup 322 and discharging an atmosphere therewithin are connected to the bottom surface of the cup 322.

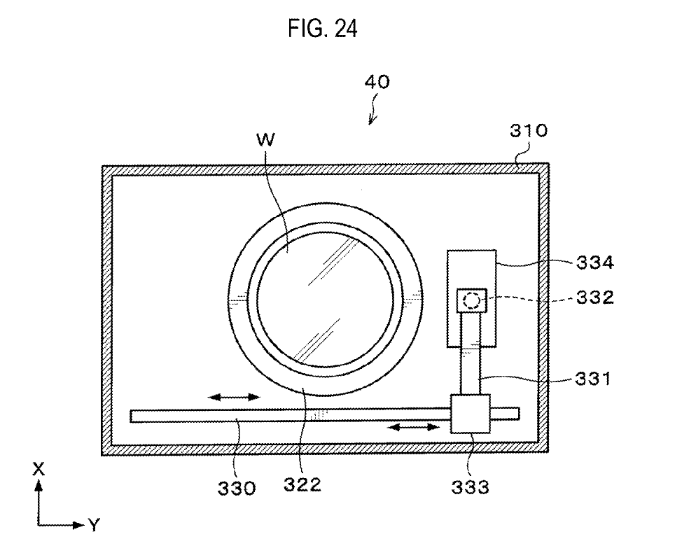

As shown in FIG. 24, a rail 330 extending in the Y-axis direction (the left-right direction in FIG. 24) is formed at the backward side of the cup 322 in the X-axis direction (at the lower side in FIG. 24). The rail 330 extends from the backwardly outer side (the left side in FIG. 24) to the forwardly outer side (the right side in FIG. 24) of the cup 322 in the Y-axis direction, for example. An arm 331 is mounted in the rail 330.

As shown in FIGS. 23 and 24, an adhesive nozzle 332 is supported by the arm 331 to supply the liquid adhesive G onto the wafer to be processed W. As shown in FIG. 24, the arm 331 is movable along the rail 330 by a nozzle drive unit 333. With this configuration, the adhesive nozzle 332 can move from a standby section 334 provided at the forwardly outer side of the cup 322 in the Y-axis direction to above the central portion of the wafer to be processed W positioned within the cup 322, and also can move above the wafer to be processed W in the diameter direction of the wafer to be processed W. The arm 331 is freely moved up and down by the operation of the nozzle drive unit 333 to adjust the height of the adhesive nozzle 332.

As shown in FIG. 23, a supply pipe 335 configured to supply the adhesive G to the adhesive nozzle 332 is connected to the adhesive nozzle 332. The supply pipe 335 is in communication with an adhesive supply source 336 to store the adhesive G therein. Further, a supply kit including a valve, a flow rate regulator or the like, which controls a flow of the adhesive G, is installed in the supply pipe 335.

A back rinse nozzle (not shown) which injects a cleaning fluid toward the rear surface of the wafer to be processed W, i.e., the non-bonding surface W_{N}, may be installed below the spin chuck 320. The cleaning fluid injected from the back rinse nozzle cleans the non-bonding surface W_{N} of the wafer to be processed W and the peripheral portion thereof

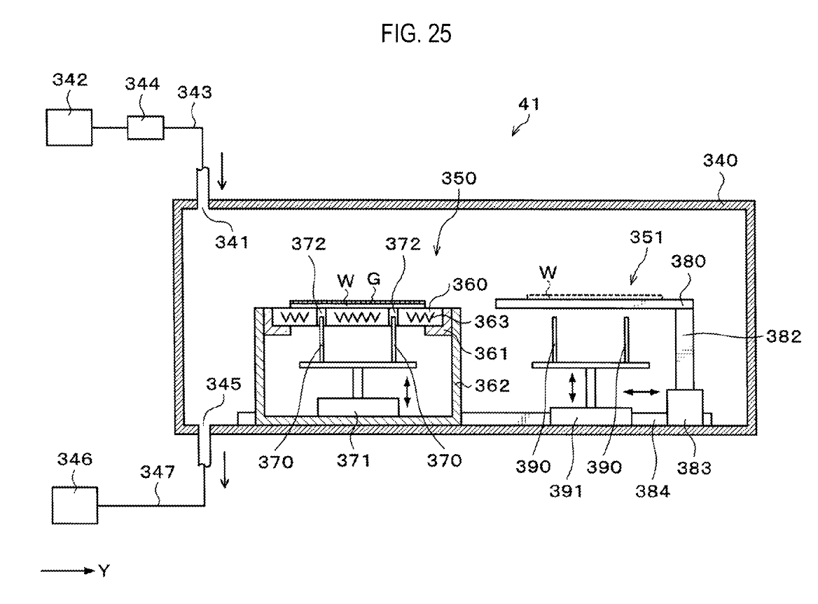

Next, a configuration of the aforementioned heat treatment units 41 to 46 will be described. As shown in FIG. 25, the heat treatment unit 41 includes an internally-sealed processing vessel 340. An inlet/outlet (not shown), through which the wafer to be processed W is carried-in/carried-out, is formed at a lateral side facing the wafer transfer zone 60 in the processing vessel 340, and an opening/closing shutter (not shown) is installed at the inlet/outlet.

A gas supply hole 341, through which an inert gas, e.g., a nitrogen gas, is supplied into the processing vessel 340, is formed in a ceiling surface of the processing vessel 340. A gas supply pipe 343 being in communication with a gas supply source 342 is connected to the gas supply hole 341. A supply kit 344 including a valve, a flow rate regulator or the like, which controls a flow of the inert gas, is installed in the gas supply pipe 343.

An air suction hole 345 for suctioning the internal atmosphere of the processing vessel 340 is formed in the bottom surface of the processing vessel 340. An air suction pipe 347 which is communication with a negative pressure generator 346 such as a vacuum pump, which is connected to the air suction hole 345.

A heating unit 350 for heating the wafer to be processed W and a temperature control unit 351 configured to control the temperature of the wafer to be processed W are installed within the processing vessel 340. The heating unit 350 and the temperature control unit 351 are arranged in the Y-axis direction.

The heating unit 350 includes an annular holding part 361 having a heat plate 360 accommodated therein, which holds a peripheral portion of the heat plate 360, and a substantially cylindrical support ring 362 which surrounds the periphery of the holding part 361. The heat plate 360, which has a substantially disc shape thickness, can heat the wafer to be processed W loaded thereon. Further, the heat plate 360 incorporates, e.g., a heating mechanism 363. For example, a heater may be used as the heating mechanism 363. A heating temperature of the heat plate 360 is controlled by, e.g., a control unit control unit 400 such that the wafer to be processed W loaded on the heat plate 360 is heated at a predetermined temperature.

A plurality of (e.g., three) elevating pins 370 which elevate the wafer to be processed W supported from the bottom are disposed below the heat plate 360. The elevating pins 370 can be moved by an elevation driver 371 upward and downward. A plurality of (e.g., three) through holes 372 which penetrate the heat plate 360 in its thickness direction are formed near the central portion of the heat plate 360. The elevating pins 370 are inserted through the through holes 372, respectively, in such a manner that they project from the top of the heat plate 360.

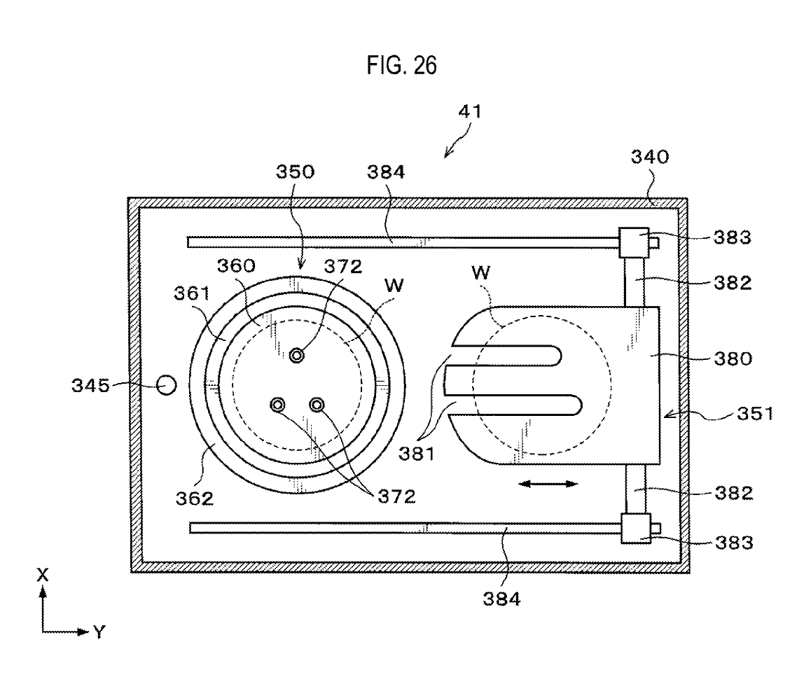

The temperature control unit 351 includes a temperature control plate 380. As shown in FIG. 26, the temperature control plate 380 has a substantially flat rectangular shape, wherein an end surface facing the heat plate 360 side is bent in a circular arc shape. Two slits 381 are formed along the Y-axis direction in the temperature control plate 380. The slits 381 extend from the end surface facing the heat plate 360 to near the central portion of the temperature control plate 380. The slits 381 prevent the temperature control plate 380 from interfering with the elevating pins 370 of the heating unit 350 and elevating pins 390 (which will be described later) of the temperature control unit 351. Further, a temperature control member (not shown), e.g., a Peltier element, is incorporated in the temperature control plate 380. A cooling temperature of the temperature control plate 380 is controlled by, e.g., the control unit 400, such that the wafer to be processed W loaded on the temperature control plate 380 is cooled down to a predetermined temperature.

As shown in FIG. 25, the temperature control plate 380 is supported by a support arm 382. A drive unit 383 is mounted to the support arm 382. The drive unit 383 is installed in a rail 384 extending in the Y-axis direction. The rail 384 extends from the temperature control unit 351 to the heating unit 350. The drive unit 383 allows the temperature control plate 380 to move between the heating unit 350 and the temperature control unit 351 along the rail 384.

The plurality of (e.g., three) elevating pins 390 which elevate the wafer to be processed W supported from the bottom are disposed below the temperature control plate 380. The elevating pins 390 can be vertically moved by an elevation driver 391. The elevating pins 390 are inserted through the slits 381, respectively, in such a manner that they project from the top of the temperature control plate 380.

Each of heat treatment units 42 to 46 have the same configuration as that of the aforementioned heat treatment unit 41 and, therefore a description thereof will be omitted to avoid duplication.

The heat treatment units 41 to 46 can also control the temperature of the overlapped wafer T. A temperature control unit (not shown) may be provided to control the temperature of the overlapped wafer T. This temperature control unit has the same configuration as that of the heat treatment unit 41 as described above, and a temperature control plate may be used as the temperature control unit instead of the heat plate 360. A cooling member (not shown), e.g., a Peltier element, is installed within the temperature control plate such that the temperature control plate can be controlled/maintained at a predetermined temperature.

As shown in FIG. 1, the control unit 400 is installed in the bonding system 1 as described above. The control unit 400 is, for example, a computer, and includes a program storage (not shown). The program storage stores a program that commands the computer to control processing of the wafer to be processed W, the support wafer S and the overlapped wafer T in the bonding system 1. The program storage also stores a program that commands the computer to control operations of a driving system including the above-described processing devices and carrying devices in order to implement a bonding process in the bonding system 1, which will be described below. The programs may be installed in the control unit 400 from a computer-readable storage medium H such as, for example, a hard disk (HD), a flexible disk (FD), a compact disk (CD), a magneto-optical disk (MO), a memory card or the like.

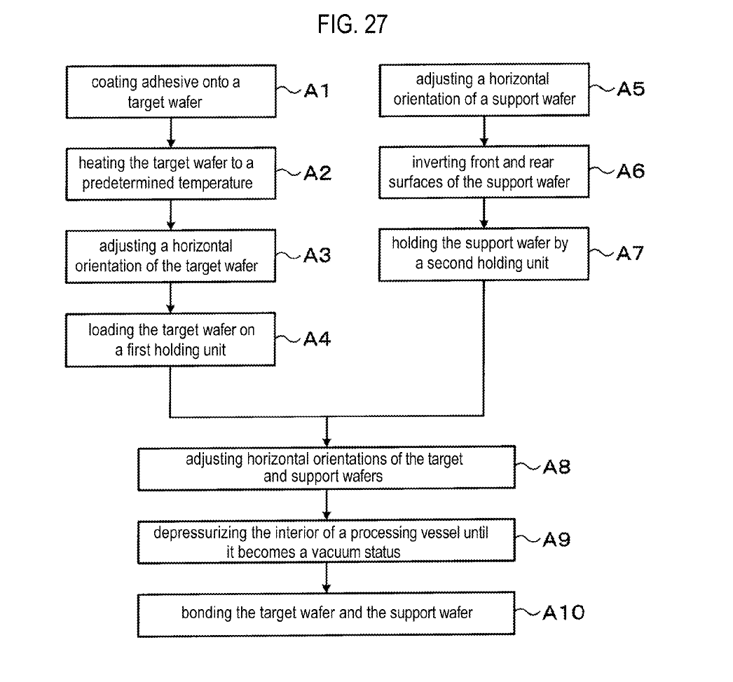

Next, a bonding process of the wafer to be processed W and the support wafer S to be performed using the bonding system 1 configured as above will be described. FIG. 27 is a flow chart showing examples of main steps of the bonding process.

First, the cassette C_{W} with a plurality of wafers to be processed W, a cassette C_{S} with a plurality of support wafers S, and an empty cassette C_{T} are loaded on a respective cassette loading board 11 of the carry-in/carry-out station 2. Thereafter, the wafer to be processed W within the cassette C_{W} is taken out by the wafer transfer unit 22, and then is transferred to the transition unit 50 of the third processing block G3 of the process station 3. As this time, the wafer to be processed W is transferred while the non-bonding surface W_{N} thereof is oriented downward.

Next, the wafer to be processed W is transferred to the coating unit 40 by the wafer transfer unit 61. The wafer to be processed W loaded into the coating unit 40 is transferred from the wafer transfer unit 61 to the spin chuck 320 so that the wafer to be processed W is adsorbed to the spin chuck 320. At this time, the non-bonding surface W_{N} of the wafer to be processed W is adsorbed to the spic chuck 320.

Subsequently, the adhesive nozzle 332 positioned within the standby part 334 is moved to the upper side of the central portion of the wafer to be processed W by the arm 331. Thereafter, the adhesive G is supplied from the adhesive nozzle 332 onto the bonding surface W_{J} of the wafer to be processed W while rotating the wafer to be processed W by the spin chuck 320. The supplied adhesive G is spread to the entire surface of the bonding surface W_{J} by virtue of the centrifugal force caused by the rotation such that the adhesive G is coated on the bonding surface W_{J} of the wafer to be processed W (Operation A1 in FIG. 27).

Then, the wafer to be processed W is transferred to the heat treatment unit 41 by the wafer transfer unit 61. At this time, the inside of the heat treatment unit 41 is maintained in an atmosphere of the inert gas. When the wafer to be processed W is loaded into the heat treatment unit 41, the overlapped wafer T is transferred from the wafer transfer unit 61 onto the elevating pins 390 that were lifted up in advance and in a standby status. Then, the elevating pins 390 are lowered down such that the wafer to be processed W is loaded onto the temperature control plate 380.

Thereafter, the temperature control plate 380 is moved to the upper side of the heat plate 360 along the rail 384 by the drive unit 383 such that the wafer to be processed W is transferred onto the elevating pins 370 that were lifted up in advance and in a standby status. Then, the elevating pins 370 are lowered down such that the wafer to be processed W is loaded on the heat plate 360. The wafer to be processed W loaded on the heat plate 360 is heated to a predetermined temperature, e.g., in a range of 100 to 300 degrees C. (Operation A2 in FIG. 27). With the heat treatment by the heat plate 360, the adhesive G residing on the wafer to be processed W is heated and hardened.

Subsequently, the elevating pins 370 are lifted up and the temperature control plate 380 moves above the heat plate 360. Thereafter, the wafer to be processed W is delivered from the elevating pins 370 to the temperature control plate 380 and the temperature control plate 380 moves toward the wafer transfer zone 60. During the movement of the temperature control plate 380, the wafer to be processed W is controlled to a predetermined temperature.

The wafer to be processed W which has been heated in the heat treatment unit 41 is transferred to the bonding unit 30 by the wafer transfer unit 61. The wafer to be processed W transferred to the bonding unit 30 is transferred from the wafer transfer unit 61 to the conveyance arm 120 of the conveyance unit 110, and further to the wafer support pins 121. Thereafter, the wafer to be processed W is transferred from the wafer support pins 121 to the inverting unit 111 by the first transfer arm 170 of the transfer unit 112.

The wafer to be processed W transferred to the inverting unit 111 is held by the holding members 151 and is moved to the position adjustment mechanism 160. In the position adjustment mechanism 160, a position of a notch portion formed in the wafer to be processed W is adjusted such that a horizontal orientation of the wafer to be processed W is adjusted (Operation A3 in FIG. 27).

Thereafter, the wafer to be processed W is transferred from the inverting unit 111 to the bonding unit 113 by the first transfer arm 170 of the transfer unit 112. At this time, since the upper chamber 292 is positioned above the lower chamber 291 and the upper and lower chambers 292 and 291 are not in contact with each other, the inside of the processing vessel 290 is not formed as a sealed space. The wafer to be processed W transferred to the bonding unit 113 is loaded on the first holding unit 200 (Operation A4 in FIG. 27). The wafer to be processed W is adsorbed to the first holding unit 200 while the bonding surface W_{J} thereof is oriented upward, that is, while the adhesive G is oriented upward.

While the operations A1 to A4 as described above are being performed on the wafer to be processed W, the support wafer S following that wafer to be processed W is processed. The support wafer S is transferred to the bonding unit 30 by the wafer transfer unit 61. A description of an operation of transferring the support wafer S to the bonding unit 30 is similar to that of the above embodiment and, therefore a description thereof will be omitted to avoid duplication.

The support wafer S transferred to the bonding unit 30 is transferred from the wafer transfer unit 61 to conveyance arm 120 of the conveyance unit 110, and further to wafer support pins 121. Thereafter, the support wafer S is transferred from the wafer support pins 121 to the inverting unit 111 by the first transfer arm 170 of the transfer unit 112.

The support wafer S transferred to the inverting unit 111 is held by the holding member 151 and is moved to the position adjustment mechanism 160. In the position adjustment mechanism 160, a position of a notch portion formed on the support wafer S is adjusted such that a horizontal orientation of the support wafer S is adjusted (Operation A5 in FIG. 27). The support wafer S whose the horizontal orientation is adjusted is horizontally moved by the position adjustment mechanism 160 and is moved vertically upward, and subsequently, the front and rear surfaces of the support wafer S are inverted (Operation A6 in FIG. 27). That is, the bonding surface S_{J} of the support wafer S is oriented downward.

Next, the support wafer S is moved vertically downward, and subsequently, is transferred from the inverting unit 111 to the bonding unit 113 by the second transfer arm 171 of the transfer unit 112. At this time, since the second transfer arm 171 holds only the peripheral portion of the bonding surface S_{J} of the support wafer S, the bonding surface S_{J} is not contaminated by, e.g., particles adhering to the second transfer arm 171. The support wafer S transferred to the bonding unit 113 is adsorbed by the second holding unit 201 (Operation A7 in FIG. 27). The support wafer S is held by the second holding unit 201 while the bonding surface S_{J} of the support wafer S is oriented downward.

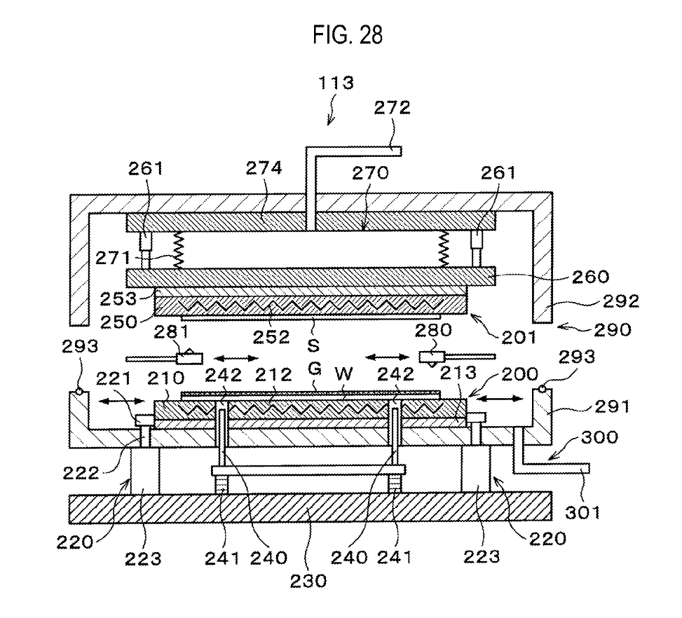

Subsequently, a horizontal position of the wafer to be processed W held by the first holding unit 200 and a horizontal position of the support wafer S held by the second holding unit 201 are adjusted. A plurality of (e.g., four or higher) predetermined reference points are formed on each of the surfaces of the wafer to be processed W and the support wafer S. As shown in FIG. 28, the first imaging unit 280 is horizontally moved such that the surface of the wafer to be processed W is imaged. Further, the second imaging unit 281 is horizontally moved such that the surface of the support wafer S is imaged. Thereafter, the horizontal position (including the horizontal orientation) of the wafer to be processed W is adjusted by a moving mechanism 220 in order to match positions of the reference points of the wafer to be processed W which are displayed on an image captured by the first imaging unit 280 and positions of the reference points of the support wafer S which are displayed on an image captured by the second imaging unit 281 with each other. Specifically, the cam 221 is rotated by the rotation driving unit 223 to horizontally move the second holding unit 201 such that the horizontal position of the wafer to be processed W is adjusted. In this way, the horizontal positions of the wafer to be processed W and the support wafer S are adjusted (Operation A8 in FIG. 27).

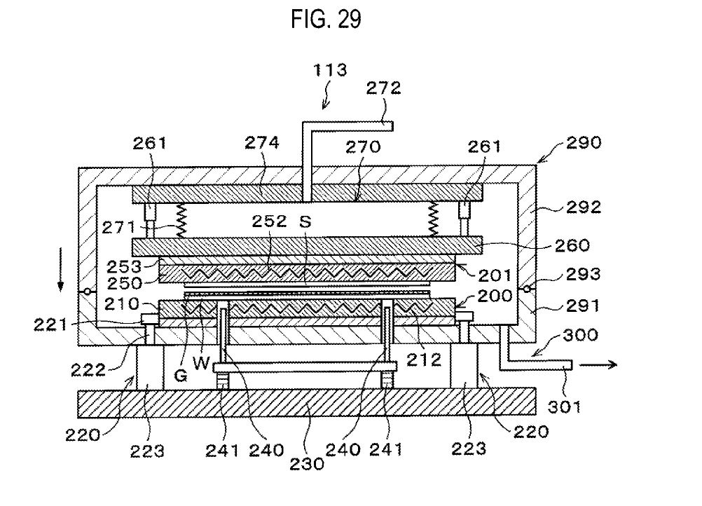

Next, as shown in FIG. 29, the first imaging unit 280 and the second imaging unit 281 are extracted from the first holding unit 200 and the second holding unit 201, and subsequently, the upper chamber 292 is lowered down by a moving mechanism (not shown). The upper chamber 292 and the lower chamber 291 are in contact with each other such that the interior of the processing vessel 290 constituted by the upper chamber 292 and the lower chamber 291 becomes a sealed space. At this time, a tiny gap is formed between the wafer to be processed W held by the first holding unit 200 and the support wafer S held by the second holding unit 201. That is, the wafer to be processed W and the support wafer S are not in contact with each other.

Thereafter, an internal atmosphere of the processing vessel 290 is sucked by the depressurization mechanism 300 such that the interior of the processing vessel 290 is depressurized until it becomes a vacuum status (Operation A9 in FIG. 27). In this embodiment, the interior of the processing vessel 290 is depressurized to a predetermined vacuum pressure, e.g., 0.01 MPa.

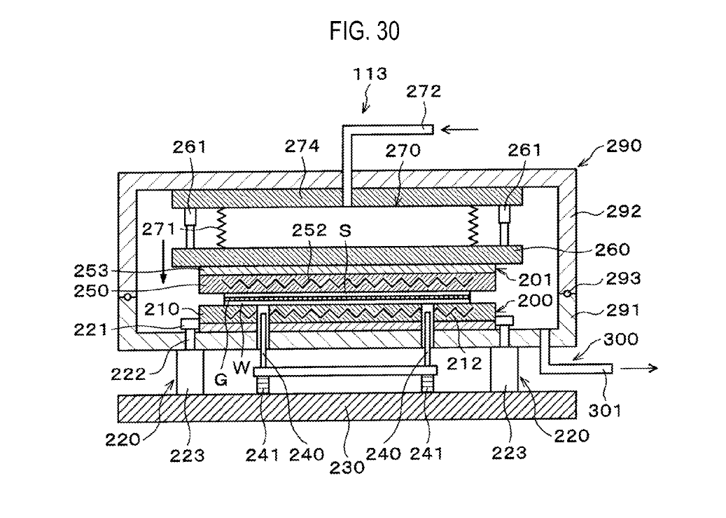

Subsequently, as shown in FIG. 30, compressed air is fed into the pressurized container 271 to maintain the interior of the pressurized container 271 at a predetermined pressure, e.g., 0.02 MPa. In this case, the interior of the processing vessel 290 maintains the vacuum status and the pressurized container 271 is in the vacuum atmosphere of the processing vessel 290. As such, a pressure to be biased downward by the pressurizing mechanism 270, i.e., a pressure to be transferred from the pressurized container 271 to the second holding unit 201, corresponds to a differential pressure (i.e., 0.01 MPa) between the pressure within the pressurized container 271 and the pressure within the processing vessel 290. Specifically, the pressure to be biased to the second holding unit 201 by the pressurizing mechanism 270 is smaller than the predetermined vacuum pressure. The second holding unit 201 is pressed downward by the pressurizing mechanism 270 such that the entire surface of the wafer to be processed W and the entire surface of the support wafer S are brought into contact with each other. When the wafer to be processed W is brought into contact with the support wafer S, since the wafer to be processed W and the support wafer S are held by the first holding unit 200 and the second holding unit 201, respectively, a misalignment between the wafer to be processed W and the support wafer S is not occurred. Further, a planar shape of the pressurized container 271 is equal to that of the wafer to be processed W and the support wafer S, which allows the pressurizing mechanism 270 to uniformly press the entire surfaces of the wafer to be processed W and the support wafer S. Further, at this time, the wafer to be processed W and the support wafer S are heated to a predetermined temperature having a predetermined range, e.g., in a range of 100 to 400 degrees C., by the heating mechanisms 212 and 252. In this way, by pressing the second holding unit 201 with a predetermined pressure by the pressurizing mechanism 270 while heating the wafer to be processed W and the support wafer S to the predetermined temperature, the wafer to be processed W and the support wafer S are more strongly adhered to each other (Operation A10 in FIG. 27). In the operation A10, since the interior of the processing vessel 290 is in the vacuum status, when the wafer to be processed W is brought into contact with the support wafer S, it is possible to prevent voids from being generated therebetween. Further, although in this embodiment, the second holding unit 201 has been described to be pressed with the pressure of 0.01 MPa by the pressurizing mechanism 270, the pressure may be set depending on the kind of the adhesive G used, the kind of a device formed on the wafer to be processed W or the like.

The overlapped wafer T produced by adhering the wafer to be processed W and the support wafer S is transferred from the bonding unit 113 to the conveyance unit 110 by the first transfer arm 170 of the transfer unit 112. The overlapped wafer T transferred to the conveyance unit 110 is conveyed to the conveyance arm 120 through the wafer support pins 121, and further is conveyed from the conveyance arm 120 to the wafer transfer unit 61.

Subsequently, the overlapped wafer T is transferred to the heat treatment unit 42 by the wafer transfer unit 61. In the heat treatment unit 42, the temperature of the overlapped wafer T is adjusted to a predetermined temperature, e.g., a normal pressure (23 degrees C.). Thereafter, the overlapped wafer T is transferred to the transition unit 51 by the wafer transfer unit 61 and subsequently, is transferred to the cassette C_{T} mounted on the respective cassette loading board 11 by the wafer transfer unit 22 of the carry-in/carry-out station 2. In this manner, the bonding process for the wafer to be processed W and the support wafer S is ended.

According to the aforementioned embodiment, it is possible to bond the wafer to be processed W and the support wafer S by pressing the second holding unit 201 toward the first holding unit 200 by the pressurizing mechanism 270 while maintaining the interior of the processing vessel 290 in the vacuum status by the depressurization mechanism 300. In this case, since the interior of the processing vessel 290 maintains the vacuum status, even if the wafer to be processed W and the support wafer S are brought into contact with each other at their entire surfaces, voids are not generated therebetween. In other words, it is possible to make the entire surface of the wafer to be processed W contact with the entire surface of the support wafer S while the wafer to be processed W is held by the first holding unit 200 and the support wafer S is held by the second holding unit 201. This prevents a misalignment from being generated between the wafer to be processed W and the support wafer S. in addition, since the pressurized container 271 is disposed within the processing vessel 290, the differential pressure (in this embodiment, 0.01 MPa) between the pressure within the pressurized container 271 and the pressure within the processing vessel 290 corresponds to the pressure to be applied to second holding unit 201 by the pressurizing mechanism 270. With this configuration, it is possible to press the wafer to be processed W and the support wafer S with a pressure lower than the above predetermined pressure. This prevents devices formed on the wafer to be processed W from being damaged. In addition, since the pressurized container 271 is disposed within the processing vessel 290, when the wafer to be processed W and the support wafer S are pressed by the pressurizing mechanism 270, there is no disturbances such as the reaction of the O-ring as described in the background section. This enables the wafer to be processed W and the support wafer S to be pressed with a uniform in-plane load. As described above, according to this embodiment, it is possible to efficiently bond the wafer to be processed W and the wafer to be processed W.

Since the interior of the processing vessel 290 is maintained in vacuum, in the case that, for example, the first holding unit 200 and the second holding unit 201 holds the wafer to be processed W and the support wafer S by vacuumization, respectively, there is a need to apply a significantly strong vacuum pressure. However, according to this embodiment, the wafer transfer section 20 and the second holding unit 201 electrostatically adsorb the wafer to be processed W and the support wafer S, respectively, which makes it possible to stably hold the wafer to be processed W and the support wafer S even if the interior of the processing vessel 290 is in vacuum.

Further, the planar shape of the pressurized container 271 is equal to that of the wafer to be processed W and the support wafer S, which makes it possible for the pressurized container 271 to press the wafer to be processed W and the support wafer S with a uniform in-plane load. For example, if the planar shape of the pressurized container 271 is larger than that of the wafer to be processed W and the support wafer S, a pressure to be applied to outer periphery portions of the wafer to be processed W and the support wafer S becomes greater than a pressure to be applied to central portions thereof. As such, as described in the above embodiment, the planar shape of the pressurized container 271 is set to be equal to that of the wafer to be processed W and the support wafer S. Thus, it is possible to stably bond the wafer to be processed W and the support wafer S.

Further, prior to bonding the wafer to be processed W and the support wafer S by the bonding unit 113, the first imaging unit 280 captures the surface of the wafer to be processed W held by the first holding unit 200 and the second imaging unit 281 captures the surface of the support wafer S held by the second holding unit 201, which makes it possible to correctly check a relative position between the wafer to be processed W and the support wafer S. With this configuration, it is possible to closely perform a horizontal alignment for the wafer to be processed W and the support wafer S based on the captured surface images. This enables the wafer to be processed W and the support wafer S to be stably bonded.

The bonding system 1 includes the bonding units 30 and 31, the coating unit 40 and the heat treatment units 41 to 46. With this configuration, the wafer to be processed W is sequentially processed in such a manner that the adhesive G is coated onto the wafer to be processed W, and then the wafer to be processed W with the adhesive G coated thereon is heated to a predetermined temperature, and simultaneously the front and rear surfaces of the support wafer S are inverted in the bonding unit 30. Thereafter, in the bonding unit 30, the wafer to be processed W with the adhesive G coated thereon which was heated to the predetermined temperature and the support wafer S whose front and rear surfaces thereof are inverted, are bonded. As described above, according to this embodiment, it is possible to handle the wafer to be processed W and the support wafer S simultaneously. Further, while the wafer to be processed W and the support wafer S are being bonded in the bonding unit 30, the coating unit 40, the heat treatment unit 41 and the bonding unit 30 can handle another wafer to be processed W and another support wafer S. Accordingly, it is possible to efficiently perform the bonding process for the wafer to be processed W and the support wafers S, which, in turn, improves a production yield in the bonding process.

While in the above embodiment, the upper chamber 292 has been described to be moved up and down, the lower chamber 291 may be moved up and down instead of the movement of the upper chamber 292. Furthermore, the processing vessel 290 may be used as a single processing vessel and a gate valve (not shown) may be installed at the inlet/outlet through which the wafer to be processed W, the support wafer S or the overlapped wafer T are passed. In either case, the interior of the processing vessel 290 can be formed as a sealed space.

A mechanical stopper (not shown) may be installed in a portion at which the upper chamber 292 is in contact with the lower chamber 291, i.e., inner surfaces of the upper chamber 292 and the lower chamber 291. With this configuration, it is possible to prevent an excessive pressure from being applied to the upper chamber 292 and the lower chamber 291, thus preventing the upper chamber 292 and the lower chamber 291 from being damaged.

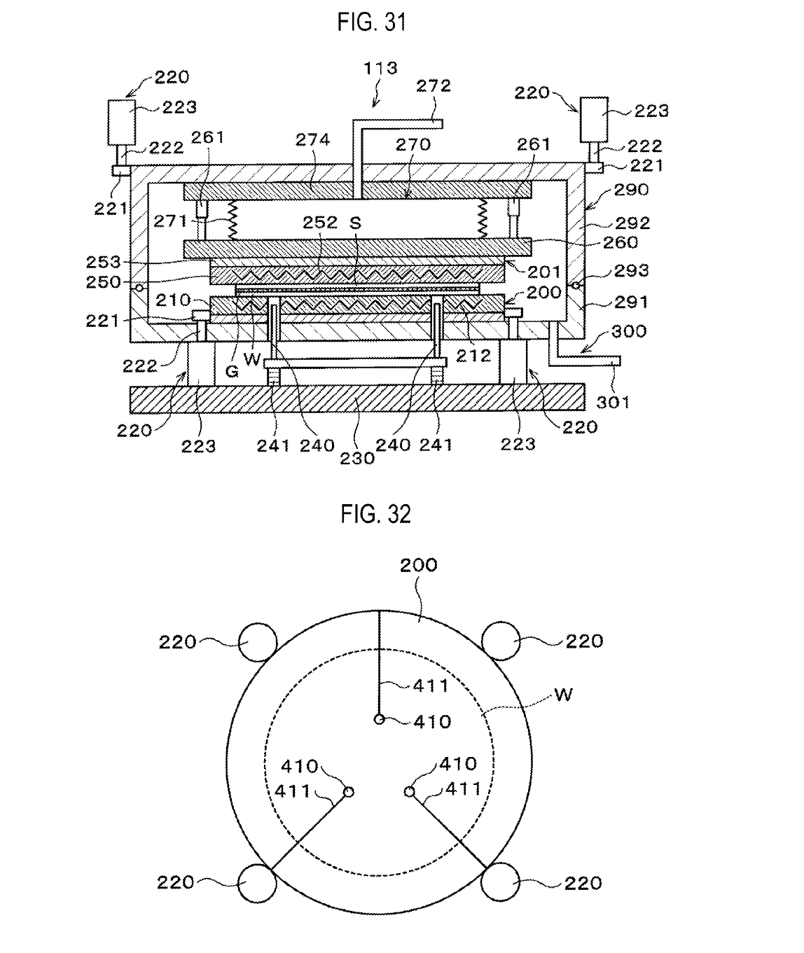

While in the above embodiment, the first holding unit 200 has been described to be horizontally moved by the moving mechanism 220, the second holding unit 201 may be horizontally moved by the moving mechanism 220. As shown in FIG. 31, the moving mechanism 220 may be installed at the side of each of the first and second holding units 200 and 201 such that the first holding unit 200 and the second holding unit 201 can be horizontally moved together.

In the above embodiment, since the first holding unit 200 is smoothly moved in the horizontal direction by the moving mechanism 220, the first holding unit 200 may be lifted up from the lower chamber 291. Various units may be employed as a part for lifting up the first holding unit 200. An air bearing or elevating pins may be employed as one example of the lifting-up part.

A maintenance window through which the interior of the processing vessel 290 is monitored, may be installed in the upper chamber 292.

While in the above embodiment, the wafer to be processed W and the support wafer S have been described to be bonded with the wafer to be processed W disposed downward and the support wafer S disposed upward, the wafer to be processed W and the support wafer S may be conversely disposed. In this configuration, the aforementioned operations A1 to A4 are performed on the support wafer S such that the adhesive G is coated onto the bonding surface S_{J} of the support wafer S. Further, the aforementioned operations A5 to A7 are performed on the wafer to be processed W such that the front and rear surfaces of the wafer to be processed W are inverted. Subsequently, the aforementioned operations A8 to A10 are performed such that the support wafer S and the wafer to be processed W are bonded. From the viewpoint of protecting electronic circuits provided on the wafer to be processed W, the adhesive G is preferably applied onto the wafer to be processed W.

As shown in FIG. 32, the first holding unit 200 according to the above embodiment may include an adsorption pad 410 as an adsorptive holding part for adsorbing the wafer to be processed W. The adsorption pad 410 may be installed at, for example, 3 places. A plurality of attraction pipes 411 for suctioning the wafer to be processed W are connected to the respective adsorption pads 410. The attraction pipes 411 are connected to a negative pressure generator (not shown) such as a vacuum pump.

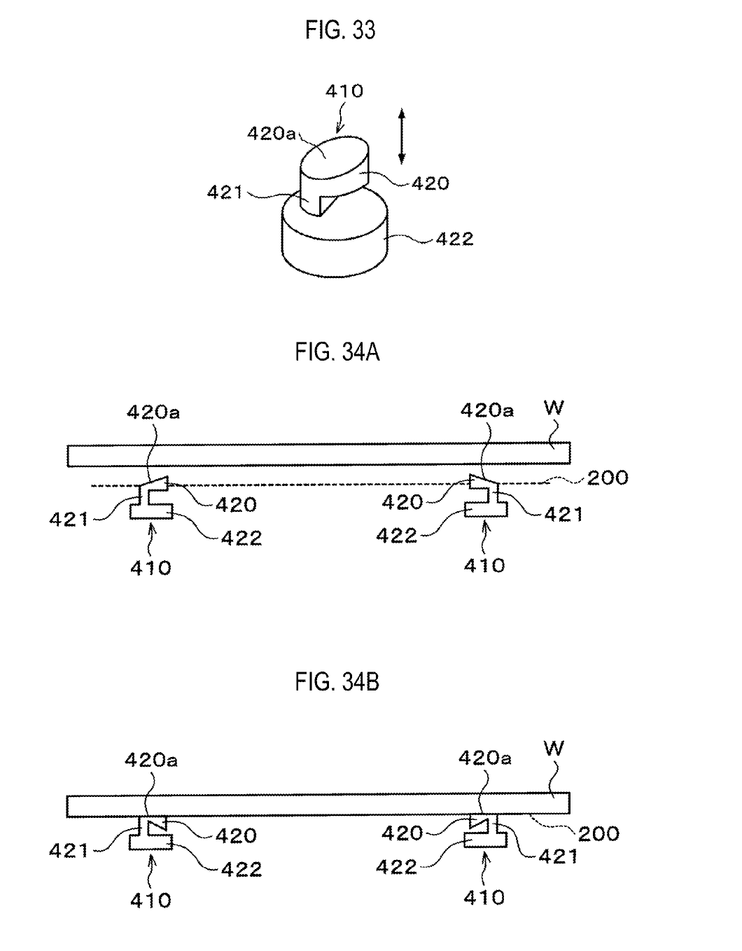

As shown in FIG. 33, each of the adsorption pads 410 includes a holding portion 420 having an adsorption surface 420a to which the non-bonding surface W_{N} of the wafer to be processed W is adsorbed, a vertically-extended supporting portion 421 for supporting the holding portion 420, and a base portion 422 for supporting the supporting portion 421. The holding portion 420 is configured to vertically move in reference to the supporting portion 421. A heat-resistant rubber may be used as one example of the adsorption pad 410. The adsorption surface 420a can hold the wafer to be processed W by friction.

As shown in FIG. 34A, in each of the adsorption pads 410, the adsorption surface 420a protrudes obliquely upward from the surface of the first holding unit 200 while they not support the wafer to be processed W. At this time, the supporting portion 421 and the base portion 422 are buried within the first holding unit 200. As shown in FIG. 34B, when the adsorption pad 410 holds the wafer to be processed W, the holding portion 420 of the adsorption pad 410 vertically moves in reference to the supporting portion 421 due to a weight of the wafer to be processed W and moves to the inside of the first holding unit 200. In this case, the adsorption surface 420a has the same height with the surface of the first holding unit 200. Subsequently, the wafer to be processed W is loaded on the surface of the first holding unit 200 and is adsorbed to the adsorption surfaces 420a. At this time, although the wafer to be processed W is attracted by the attraction pipes 411 and an attractive force of the attraction pipe 411 is the same vacuum pressure as the internal atmosphere of the processing vessel 290, the wafer to be processed W don't moves due to a friction between the adsorption surfaces 420a and the wafer to be processed W. With this configuration, the wafer to be processed W is stably adsorbed and held by the first holding unit 200. Thus, it is possible to stably bond the wafer to be processed W and the support wafer S.

Further, the first holding unit 200 may not include the electrostatic chuck 210, and the first holding unit 200 may include both the electrostatic chuck 210 and the adsorption pads 410. When the first holding unit 200 includes both the electrostatic chuck 210 and the adsorption pads 410, the first holding unit 200 can more stably adsorb the wafer to be processed W.

In the case that the wafer to be processed W is disposed upward and the support wafer S is disposed downward, that is, the second holding unit 201 is disposed below the first holding unit 200, the second holding unit 201 may include the adsorption pads 410 and the attraction pipes 411 as described above.

Further, while in the above embodiment, the adhesive G has been described to be coated on any one of the wafer to be processed W and the support wafer S by the coating unit 40, the adhesive G may be coated both the wafer to be processed W and the support wafer S.

While in the above embodiment, the wafer to be processed W has been described to be heated to the predetermined temperature having the range of 100 to 300 degrees C. in the operation A3, the wafer to be processed W may be subjected to heat treatment in two steps. For example, the wafer to be processed W may be heated to a first heat treatment temperature, e.g., in a range of 100 to 150 degrees C. in the heat treatment unit 41, and subsequently, may be heated to a second heat treatment temperature, e.g., in a range of 150 to 300 degrees C. in the heat treatment unit 44. With this configuration, it is possible to constantly maintain temperatures of heating mechanisms provided in the heat treatment units 41 and 44. This eliminates the need for adjusting the temperatures of the heating mechanisms, which makes it possible to further improve a production yield of the bonding process for the wafer to be processed W and the support wafer S.

The present disclosure may be applied to other various substrates including a flat panel display (FPD), a mask reticle for photomask and so on, in addition to the wafers.

According to the present disclosure in some embodiments, it is possible to stably bond the wafer to be processed and the support wafer.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A bonding apparatus for bonding a substrate to be processed and a support substrate, comprising:
a first holding unit configured to hold the substrate to be processed;
a second holding unit disposed to face the first holding unit, and configured to hold the support substrate;
a pressurizing mechanism including a vertically-expansible pressure vessel which is installed to cover the substrate to be processed held by the first holding unit and the support substrate held by the second holding unit, the pressurizing mechanism being installed in any one of the first holding unit and the second holding unit and configured to flow air into the pressure vessel and press the second holding unit and the first holding unit towards each other;
an internally-sealable processing vessel configured to receive the first holding unit, the second holding unit and the pressure vessel; and
a depressurization mechanism configured to depressurize an internal atmosphere of the processing vessel.

2. The bonding apparatus of claim 1, further comprising a control unit configured to control the first holding unit, the second holding unit and the pressurizing mechanism to bring into the entire surface of the substrate to be processed held by the first holding unit to be in contact with the entire surface of the support substrate held by the second holding unit, and to press the substrate to be processed and the support substrate.

3. The bonding apparatus of claim 1, wherein the first holding unit electrostatically adsorbs the substrate to be processed, and
wherein the second holding unit electrostatically adsorbs the support substrate.

4. The bonding apparatus of claim 1, wherein the first holding unit or the second holding unit include an adsorptive holding part configured to adsorb the substrate to be processed or the support substrate, and
wherein the substrate to be processed or the support substrate is adsorbed to an adsorption surface of the adsorptive holding part by friction.

5. The bonding apparatus of claim 1, wherein a planar shape of the pressure vessel is identical to a planar shape of the support substrate.

6. The bonding apparatus of claim 1, further comprising:
a first imaging unit configured to image a surface of the substrate to be processed held by the first holding unit;
a second imaging unit configured to image a surface of the support substrate held by the second holding unit; and
a moving mechanism configured to horizontally move the first holding unit or the second holding unit with respect to each other.

7. A bonding system including the bonding apparatus of claim 1, further comprising:
a process station including the bonding apparatus, a coating unit configured to coat an adhesive onto a substrate to be processed or a support substrate, a heat treatment unit configured to heat the substrate to be processed or the support substrate onto which the adhesive is coated to a predetermined temperature, a transfer zone through which the substrate to be processed, the support substrate or an overlapped wafer obtained by overlapping the substrate to be processed and the support substrate is transferred to the coating unit, the heat treatment unit and the bonding apparatus; and
a carry-in/carry-out station in which the substrate to be processed, the support substrate or the overlapped wafer is carried into/carried out of the process station.

8. A method of bonding a substrate to be processed and a support substrate using a bonding apparatus,
wherein the bonding apparatus includes:
a first holding unit configured to hold the substrate to be processed;
a second holding unit disposed to face the first holding unit and configured to hold the support substrate;
a pressurizing mechanism including a vertically-expansible pressure vessel which is installed to cover the substrate to be processed held by the first holding unit and the support substrate held by the second holding unit, the pressurizing mechanism being installed in any one of the first holding unit and the second holding unit and configured to flow air into the pressure vessel and press the second holding unit and the first holding unit towards each other;
an internally-sealable processing vessel configured to receive the first holding unit, the second holding unit and the pressure vessel; and
a depressurization mechanism configured to depressurize an internal atmosphere of the processing vessel,
the method comprising:
disposing the substrate to be processed held by the first holding unit and the support substrate held by the second holding unit oppositely to each other and depressurizing the interior of the processing vessel in vacuum by the depressurization mechanism; and
pressing the second holding unit toward the first holding unit by the pressurizing mechanism while maintaining the interior of the processing vessel in vacuum.

9. The method of claim 8, wherein in the pressing, a pressure to be applied to the second holding unit is lower than a vacuum pressure.

10. The method of claim 8, wherein the pressing includes making the entire surface of the substrate to be processed held by the first holding unit to be in contact with the entire surface of the support substrate held by the second holding unit, and pressing the substrate to be processed and the support substrate.

11. The method of claim 8, wherein the first holding unit electrostatically adsorbs the substrate to be processed, and
wherein the second holding unit electrostatically adsorbs the support substrate.

12. The method of claim 8, wherein the first holding unit or the second holding unit include an adsorptive holding part for adsorbing the substrate to be processed or the support substrate, and
wherein an adsorption surface of the adsorptive holding part holds the substrate to be processed or the support substrate by friction.

13. The method of claim 8, wherein a planar shape of the pressure vessel is identical to a planar shape of the support substrate, and
wherein in the pressing, the pressurizing mechanism presses the entire surface of the support substrate.

14. The method of claim 8, comprising, imaging the surface of the substrate to be processed and the surface of the support substrate, respectively, before the depressurizing, and adjusting relative horizontal positions of the substrate to be processed and the support substrate such that a reference point formed on the imaged surface of the substrate to be processed is matched with a reference point formed on the imaged surface of the support substrate.
